(19) United States
(12) Patent Application Publication
(10) Pub. No.: US 2025/0292049 A1
(43) Pub. Date: Sep. 18, 2025

(54) TAPE PRINTING APPARATUS AND CONTROL METHOD OF TAPE PRINTING APPARATUS

(71) Applicant: SEIKO EPSON CORPORATION, Tokyo (JP)

(72) Inventor: Hideyuki TSUKUDA, Matsumoto-shi (JP)

(73) Assignee: SEIKO EPSON CORPORATION, Tokyo (JP)

(21) Appl. No.: 19/077,895

(22) Filed: Mar. 12, 2025

(30) Foreign Application Priority Data
Mar. 13, 2024 (JP) 2024-039146
Apr. 16, 2024 (JP) 2024-066168

(51) Int. Cl. G06K 15/02

(52) U.S. Cl. CPC G06K 15/1842; G06K 15/022; G06K 2215/0054

(57) ABSTRACT

A tape printing apparatus includes a display portion and a control portion, in which the control portion controls the display portion based on image data representing a first character selected from a first character selection screen such that the selected first character is displayed on a text screen as a character constituting text to be printed, receives an flip instruction to display, on the text screen in place of the first character, a first flipped character in which the first character is subjected to character flip, generates first flipped image data representing the first flipped character based on the image data representing the first character when the flip instruction is received, and controls the display portion based on the generated first flipped image data such that the first flipped character is displayed on the text screen in place of the first character as the character constituting the text.

The present application is based on, and claims priority from JP Application Serial Number 2024-039146, filed Mar. 13, 2024 and JP Application Serial Number 2024-066168, filed Apr. 16, 2024, the disclosures of which are hereby incorporated by reference herein in their entirety.

### BACKGROUND

### 1. Technical Field

The present disclosure relates to a tape printing apparatus and a control method of a tape printing apparatus.

### 2. Related Art

In the related art, as disclosed in JP-A-2005-103929, a tape printing apparatus is known that is capable of forming a front ruling portion and a rear ruling portion of an outer frame surrounding a paragraph with pictograms. This tape printing apparatus conserves the storage capacity of a memory element by forming the front ruling portion of the outer frame with pictograms stored in the memory element and forming the rear ruling portion of the outer frame with pictograms that are left-right flipped from the pictograms stored in the memory element.

In the tape printing apparatus in the related art, in a text screen where text to be printed on a tape is edited, in place of a first character input from a first character selection screen as a character constituting the text, it is not possible to display a first flipped character in which the first character is subjected to character flip including at least one of left-right flip, black-white inversion, and up-down flip. Furthermore, in the tape printing apparatus in the related art, it is not possible to display an flipped outer frame in which the entire outer frame is subjected to outer frame flip including at least one of left-right flip and up-down flip, based on image data representing the outer frame.

### SUMMARY

According to an aspect of the present disclosure, there is provided a tape printing apparatus including: a display portion; and a control portion having a storage section that stores image data representing a character, in which the control portion receives a selection of one first character from among a plurality of first characters on a first character selection screen displayed on the display portion, the control portion controls the display portion based on the image data representing the selected first character such that the selected first character is displayed on a text screen as a character constituting text to be printed, the control portion receives an flip instruction to display, on the text screen in place of the first character, a first flipped character in which the first character is subjected to character flip including at least one of left-right flip, black-white inversion, and up-down flip, the control portion generates first flipped image data representing the first flipped character based on the image data representing the first character when the flip instruction is received, and the control portion controls the display portion based on the generated first flipped image data such that the first flipped character is displayed on the text screen in place of the first character as the character constituting the text.

According to another aspect of the present disclosure, there is provided a control method of a tape printing apparatus including a display portion and a storage section that stores image data representing a character, the control method including: receiving a selection of one first character from among a plurality of first characters on a first character selection screen displayed on the display portion; controlling the display portion based on the image data representing the selected first character such that the selected first character is displayed on a text screen as a character constituting text to be printed; receiving an flip instruction to display, on the text screen in place of the first character, a first flipped character in which the first character is subjected to character flip including at least one of left-right flip, black-white inversion, and up-down flip; generating first flipped image data representing the first flipped character based on the image data representing the first character when the flip instruction is received; and controlling the display portion based on the generated first flipped image data such that the first flipped character is displayed on the text screen in place of the first character as the character constituting the text.

According to still another aspect of the present disclosure, there is provided a tape printing apparatus including: a display portion; and a control portion having a storage section that stores image data representing an outer frame to be printed on a tape, in which the control portion receives an input of text to be disposed within the outer frame and printed on the tape, an input of a non-flipped outer frame based on the image data as the outer frame, and an input of an flipped outer frame in which the entire non-flipped outer frame is subjected to outer frame flip including at least one of left-right flip and up-down flip as the outer frame, and the control portion generates flipped image data representing the flipped outer frame based on the image data, and controls the display portion such that the flipped outer frame based on the generated flipped image data and the text disposed within the flipped outer frame without either left-right flip or up-down flip are displayed when the input of the flipped outer frame is received.

According to still another aspect of the present disclosure, there is provided a control method of a tape printing apparatus including a display portion and a storage section that stores image data representing an outer frame to be printed on a tape, the control method including: by the tape printing apparatus, receiving an input of text to be disposed within the outer frame and printed on the tape, an input of a non-flipped outer frame based on the image data as the outer frame, and an input of an flipped outer frame in which the entire non-flipped outer frame is subjected to outer frame flip including at least one of left-right flip and up-down flip as the outer frame; and generating flipped image data representing the flipped outer frame based on the image data, and controlling the display portion such that the flipped outer frame based on the generated flipped image data and the text disposed within the flipped outer frame without either left-right flip or up-down flip are displayed when the input of the flipped outer frame is received.

### BRIEF DESCRIPTION OF THE DRAWINGS

FIG. 1 is an external perspective view of a tape printing apparatus and a tape cartridge.

FIG. 2 is a diagram showing a text screen.

FIG. 3 is a block diagram showing a hardware configuration of the tape printing apparatus.

FIG. 4 is a diagram showing a character table.

FIG. 5 is a diagram showing a label on which a first character and a first flipped character are printed.

FIG. 6 is a flowchart of an editing and printing process.

FIG. 7 is a flowchart of a first character selection process.

FIG. 8 is a diagram showing a first character selection screen.

FIG. 9 is a flowchart of a character flip process.

FIG. 10 is a diagram showing an flip menu screen.

FIG. 11 is a diagram showing a text screen on which a first left-right flipped character is displayed.

FIG. 12 is a diagram showing a text screen on which a first black-white inverted character is displayed.

FIG. 13 is a diagram showing a text screen on which a first up-down flipped character is displayed.

FIG. 14 is a diagram showing a text screen on which three first characters are displayed.

FIG. 15 is a diagram showing a text screen on which three partially flipped characters are displayed in place of the three first characters shown in FIG. 14.

FIG. 16 is a diagram showing a label printed based on results of editing the text on the text screen shown in FIG. 2.

FIG. 17 is a diagram showing a label printed based on results of editing the text on the text screen shown in FIG. 11.

FIG. 18 is a diagram showing a text screen.

FIG. 19 is a diagram showing an outer frame table.

FIG. 20 is a diagram showing a label on which a non-flipped outer frame and text are printed.

FIG. 21 is a diagram showing a label on which left-right flipped outer frame and text are printed.

FIG. 22 is an explanatory diagram of left-right flip and up-down flip.

FIG. 23 is a diagram showing a text screen on which text is displayed.

FIG. 24 is a diagram showing an outer frame selection screen in a state in which an outer frame candidate with outer frame number “00” is selected.

FIG. 25 is a diagram showing an outer frame selection screen in a state in which an outer frame candidate with outer frame number “15” is provisionally selected.

FIG. 26 is a diagram showing an flip type selection screen in a state in which an flip type candidate indicating “not flipped” is selected.

FIG. 27 is a diagram showing an flip type selection screen in a state in which an flip type candidate indicating “left-right flip” is selected.

FIG. 28 is a diagram showing a text screen on which a left-right flipped outer frame and text are displayed.

FIG. 29 is a diagram showing an outer frame selection screen in a state in which an outer frame candidate with outer frame number “11” is provisionally selected.

FIG. 30 is a diagram showing a text screen on which a non-flipped outer frame and text are displayed.

FIG. 31 is a flowchart of an editing and printing process.

FIG. 32 is a flowchart of an outer frame display process.

FIG. 33 is a flowchart continuing from FIG. 32.

FIG. 34 is a diagram showing a label on which a left-right-black-white inverted outer frame and black-white inverted text are printed.

### DESCRIPTION OF EMBODIMENTS

A tape printing apparatus 1 as an embodiment of a tape printing apparatus will be described below with reference to the accompanying drawings.

### Overview of Tape Printing Apparatus and Tape Cartridge

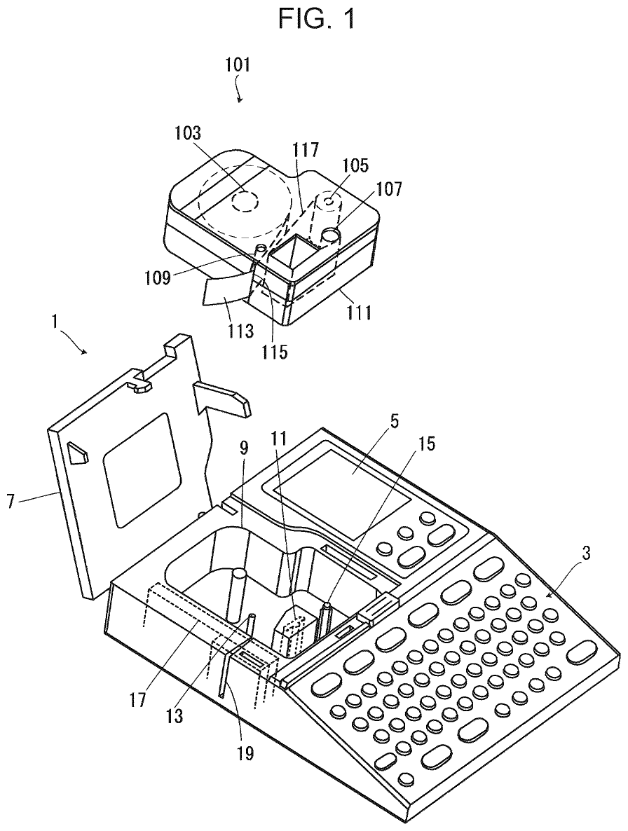

As shown in FIG. 1, the tape printing apparatus 1 includes an operation panel 3, a display portion 5, a cover 7, a cartridge mounting portion 9, a print head 11, a platen shaft 13, a take-up shaft 15, and a cutter 17.

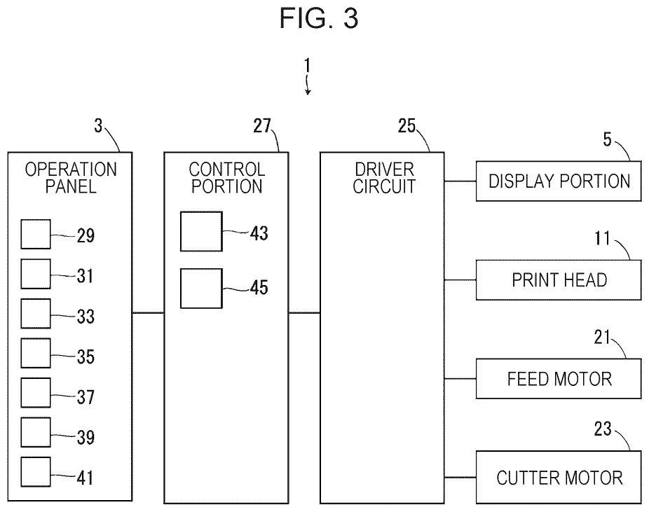

The operation panel 3 is provided with various keys such as a character key 29 shown in FIG. 3.

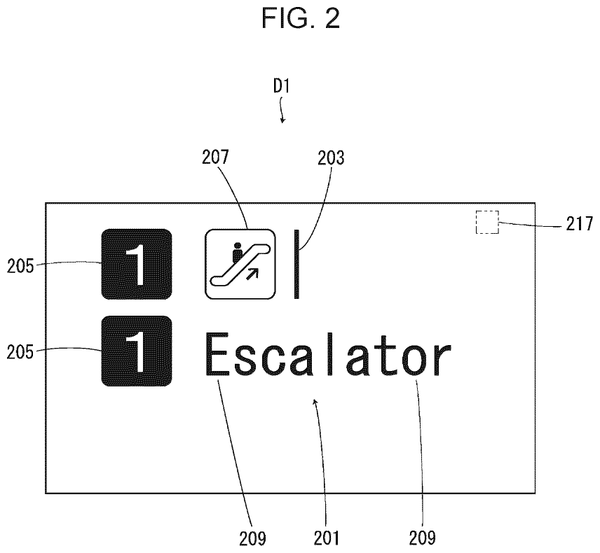

The display portion 5 displays a text screen D1 and the like shown in FIG. 2. As the display portion 5, for example, a liquid crystal display or an organic EL display can be used.

The cover 7 opens and closes the cartridge mounting portion 9. The cover 7 is opened and closed when, for example, a user mounts a tape cartridge 101 into the cartridge mounting portion 9. The tape cartridge 101 is detachably mounted on the cartridge mounting portion 9.

The tape cartridge 101 includes a tape core 103, a feeding core 105, a take-up core 107, a platen roller 109, and a cartridge case 111 that accommodates these components. A tape 113 serving as a print medium is wound around the tape core 103. The tape 113 fed from the tape core 103 is sent out of the cartridge case 111 through a tape feed port 115 provided in the cartridge case 111. An ink ribbon 117 is wound around the feeding core 105. The ink ribbon 117 fed from the feeding core 105 is taken up by the take-up core 107.

The print head 11 prints on the tape 113. When the tape cartridge 101 is mounted in the cartridge mounting portion 9, the print head 11 pinches the tape 113 and the ink ribbon 117 between print head 11 and the platen roller 109. In this state, the print head 11 generates heat, causing the ink on the ink ribbon 117 to be transferred to the tape 113.

When the tape cartridge 101 is mounted in the cartridge mounting portion 9, the platen shaft 13 and the take-up shaft 15 are inserted into the platen roller 109 and the take-up core 107, respectively. Accordingly, the power of a feed motor 21 shown in FIG. 3 can be transmitted to the platen roller 109 and the take-up core 107. As the platen roller 109 rotates, the tape 113 and the ink ribbon 117 pinched between the platen roller 109 and the print head 11 are advanced. Furthermore, as the take-up core 107 rotates, the ink ribbon 117 is taken up by the take-up core 107.

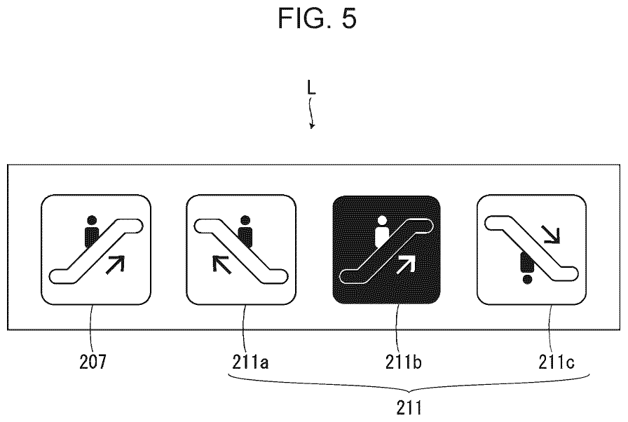

The cutter 17 is provided between the cartridge mounting portion 9 and a tape discharge port 19. The cutter 17 cuts the tape 113 sent out from the tape cartridge 101 mounted in the cartridge mounting portion 9 in a width direction of the tape 113. Accordingly, the printed portion of the tape 113 is cut off, and the cut-off printed portion of the tape 113 is used as a label L shown in FIG. 5.

### Text Screen

FIG. 2 shows a text screen D1 displayed on the display portion 5. On the text screen D1, a user edits text 201 printed on the tape 113. On the text screen D1, the text 201, a cursor 203, and a line head mark 205 are displayed. The text 201 is made up of one or more paragraphs, and each paragraph is made up of one or more lines. In the example shown in FIG. 2, the text 201 is made up of two paragraphs, and each paragraph is made up of one line. The line head mark 205 indicates the line number of the line in each paragraph. The text 201 is made up of one or more characters. The components of the text 201 do not include the outer frame surrounding the paragraph.

Here, the characters constituting the text 201 are classified into a first character 207 and a second character 209 due to the difference in the input method.

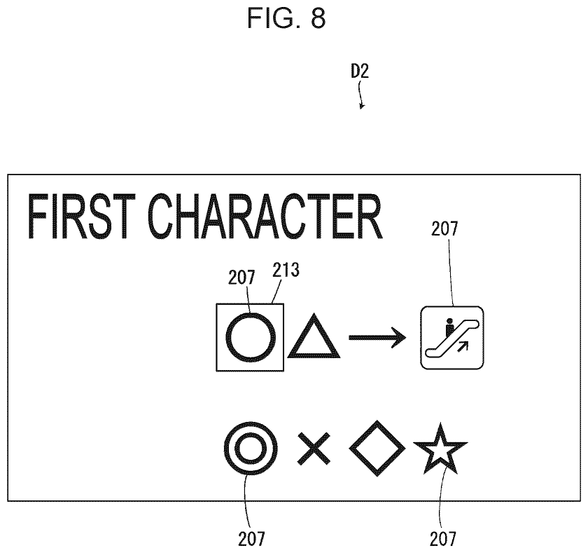

The first character 207 refers to a character that is input based on a selection made on a first character selection screen D2 shown in FIG. 8, which will be described later. The first character 207 includes, for example, symbols and pictograms. In the example shown in FIG. 2, the first character 207 is a pictogram representing an escalator input in the first paragraph. The first character 207 includes characters that can be input from either the first character selection screen D2 or the character key 29.

The second character 209 refers to a character that is directly input using the character key 29 without using the first character selection screen D2. The second character 209 includes, for example, hiragana, katakana, kanji, Roman letters, numbers, and the like. In the example shown in FIG. 2, the characters of “Escalator” input in a second paragraph are second characters 209.

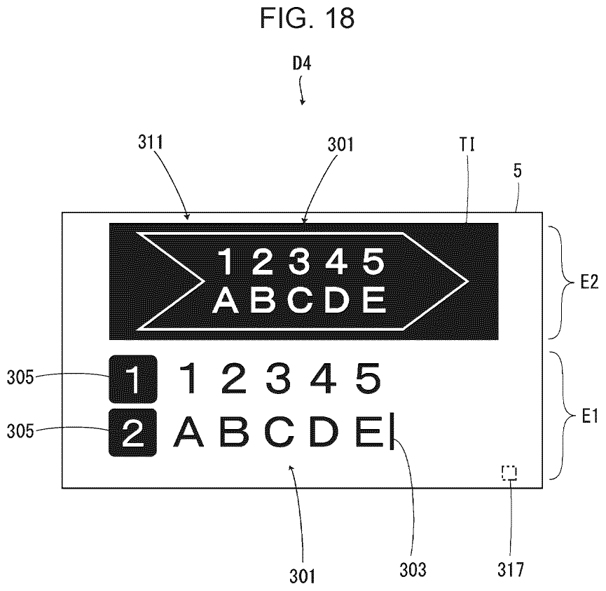

FIG. 18 is a diagram showing a text screen D4 displayed on the display portion 5. The text screen D4 is partitioned into a text input area E1 at the bottom of the screen and a print image display area E2 at the top of the screen.

In the text input area E1, text 301 printed on the tape 113 is edited by the user. On the text input area E1, the text 301, a cursor 303, and a line head mark 305 are displayed. The text 301 is made up of one or more characters. Moreover, the text 301 is made up of one or more lines. In the example shown in FIG. 18, the text 301 is made up of two lines. The line head mark 305 indicates the line number of the line.

In the print image display area E2, a print image is displayed. In the example shown in FIG. 18, a non-flipped outer frame 311, the text 301, and a tape image TI are displayed as the print image.

Here, the non-flipped outer frame 311 refers to an outer frame in which neither left-right flip nor up-down flip is performed. The tape printing apparatus 1 according to the present embodiment includes a storage section 45 shown in FIG. 3 that stores image data representing an outer frame printed on the tape 113. The non-flipped outer frame 311 is an outer frame based on the image data stored in the storage section 45. In addition, the tape printing apparatus 1 can receive, as an outer frame, an input of the non-flipped outer frame 311 and an input of an flipped outer frame in which the entire non-flipped outer frame 311 is subjected to outer frame flip including at least one of left-right flip and up-down flip.

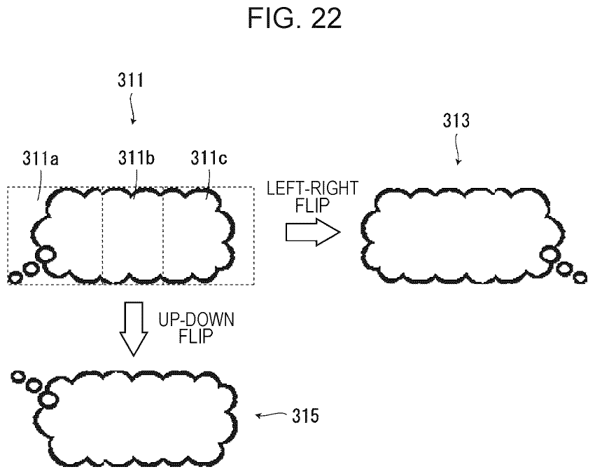

In the present embodiment, it is assumed that outer frame flip refers to either left-right flip or up-down flip. Therefore, in the present embodiment, the flipped outer frame refers to either a left-right flipped outer frame 313 in which the entire non-flipped outer frame 311 is subjected to left-right flip, or an up-down flipped outer frame 315 in which the entire non-flipped outer frame 311 is subjected to up-down flip, as shown in FIG. 22.

The tape image TI included in the print image is an imitation of the tape 113. Furthermore, the text 301 included in the print image is based on the text 301 input in the text input area E1.

In the print image display area E2, the print image is displayed in black-white inversion. Therefore, as shown in FIG. 18, the tape image TI included in the print image is displayed with the tape color in black, and the non-flipped outer frame 311 and the text 301 are displayed in white. The same applies when the print image includes the left-right flipped outer frame 313 or the up-down flipped outer frame 315.

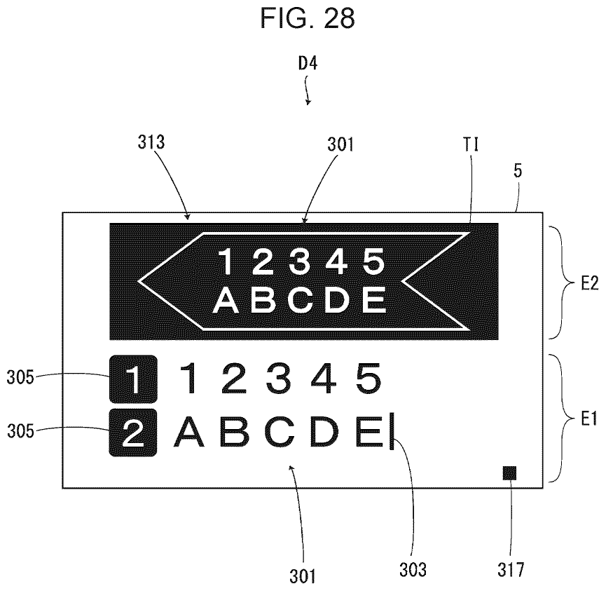

In addition, an flip indicator 317 is provided on the text screen D4. Although not shown, a word meaning “outer frame flip” is written on the edge portion of the display portion 5 at a position corresponding to the flip indicator 317. When an flipped outer frame is displayed in the print image display area E2, the tape printing apparatus 1 turns on the flip indicator 317 as shown in FIG. 28, and when an flipped outer frame is not displayed, the tape printing apparatus 1 turns off the flip indicator 317. In other words, when the left-right flipped outer frame 313 or the up-down flipped outer frame 315 is displayed in the print image display area E2, the tape printing apparatus 1 turns on the flip indicator 317, and when neither the left-right flipped outer frame 313 nor the up-down flipped outer frame 315 is displayed, the tape printing apparatus 1 turns off the flip indicator 317.

### Hardware Configuration of Tape Printing Apparatus

As shown in FIG. 3, the tape printing apparatus 1 includes a feed motor 21, a cutter motor 23, a driver circuit 25, and a control portion 27, in addition to the above-described display portion 5 and the like.

The feed motor 21 is a drive source of the platen roller 109 and the take-up core 107. The cutter motor 23 is a drive source of the cutter 17.

The control portion 27 controls each portion of the tape printing apparatus 1. That is, the control portion 27 outputs control signals to the driver circuit 25 that drives the display portion 5, the print head 11, the feed motor 21 and the cutter motor 23. In addition, an output signal from the operation panel 3 is input to the control portion 27. The operation panel 3 is provided with the character key 29, a cursor key 31, a selection key 33, a print key 35, a first character display key/outer frame key 37, a back key 39, an flip key 41, and the like. The cursor key 31 is a key marked with arrows “↑”, “↓”, “→”, and “←” to indicate the direction of cursor movement.

The control portion 27 includes a processor 43 and a storage section 45. As the processor 43, for example, a central processing unit (CPU) or an application specific integrated circuit (ASIC) can be used. The processor 43 reads out the programs stored in the storage section 45 and executes various types of arithmetic processing using the work area in the storage section 45.

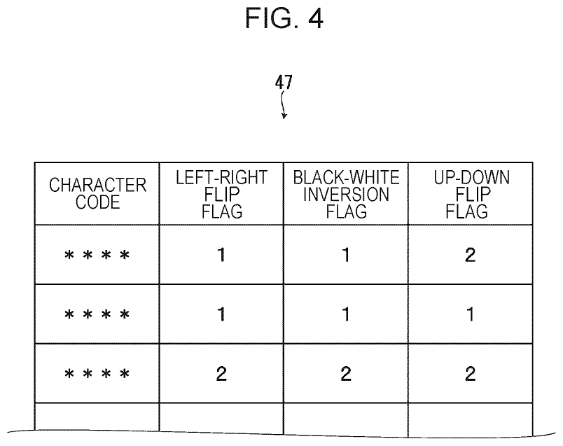

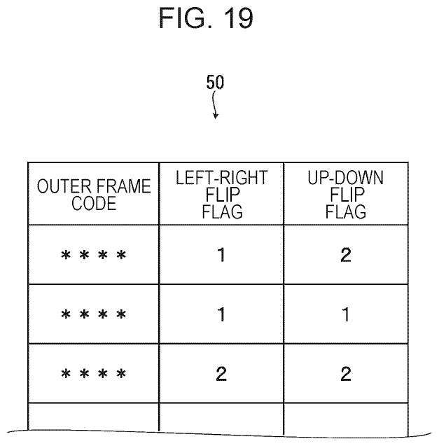

The storage section 45 includes, for example, storage elements such as a read only memory (ROM), a character generator ROM (CGROM), and a random access memory (RAM). The storage section 45 stores, in addition to various programs, image data, a character table 47 shown in FIG. 4, and an outer frame table 50 shown in FIG. 19. The image data is bitmap data representing characters and outer frames, and is stored in association with a character code of each character and an outer frame code of each outer frame.

As shown in FIG. 4, the character table 47 associates a character code with a left-right flip flag, a black-white inversion flag, and an up-down flip flag for each character. When the left-right flip flag is “1”, this means that left-right flip, which will be described later, is permitted, and when the left-right flip flag is “2”, this means that left-right flip is prohibited. For example, for a character such as “H” that does not change appearance even when left-right flip is performed, the left-right flip flag is set to “2”. The same applies to the black-white inversion flag and the up-down flip flag. For the second character 209, the left-right flip flag, the black-white inversion flag, and the up-down flip flag are all set to “2”.

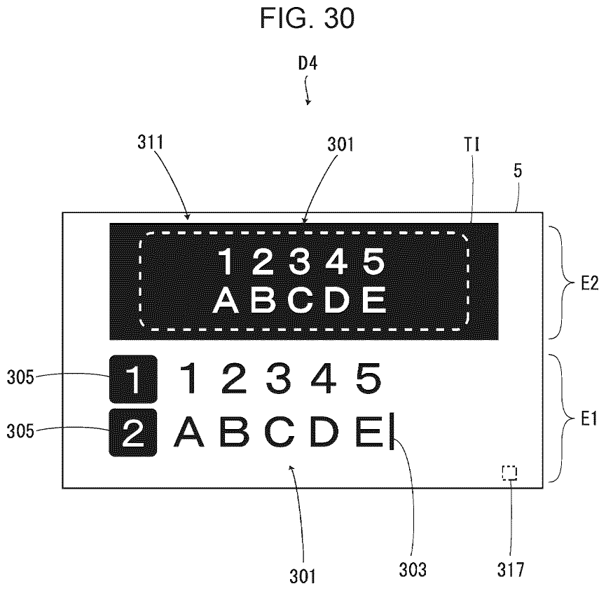

As shown in FIG. 19, the outer frame table 50 associates an outer frame code with a left-right flip flag and an up-down flip flag for each outer frame. When the left-right flip flag is “1”, this means that left-right flip is permitted, and when the left-right flip flag is “2”, this means that left-right flip is prohibited. For example, for an outer frame that does not change appearance even when up-down flip is performed, such as the non-flipped outer frame 311 shown in FIG. 18, the up-down flip flag is set to “2”. For an outer frame that does not change appearance even when either left-right flip or up-down flip is performed, such as a non-flipped outer frame 311 shown in FIG. 30, both the left-right flip flag and up-down flip flag are set to “2”. Here, “an outer frame that does not change appearance even when up-down flip is performed” refers to an outer frame that has a shape that is linearly symmetrical with respect to a virtual center line extending in the left-right direction in FIG. 30 as the axis of symmetry, and whose overall shape does not change even when up-down flip is performed. In addition, “an outer frame that does not change appearance even when left-right flip is performed” refers to an outer frame that has a shape that is linearly symmetrical with respect to a virtual center line extending in the vertical direction in FIG. 30 as the axis of symmetry, and whose shape does not change even when left-right flip is performed.

In the following description, an outer frame for which at least one of the left-right flip flag or the up-down flip flag is set to “1” will be referred to as an “outer frame that can be subjected to outer frame flip”. Moreover, an outer frame for which both the left-right flip flag and the up-down flip flag are set to “2” will be referred to as an “outer frame that cannot be subjected to outer frame flip”.

### Character Inversion

As shown in FIG. 5, it is convenient that the tape printing apparatus 1 can print not only the first character 207 but also a first flipped character 211 in which the first character 207 is subjected to character flip. Therefore, it is conceivable to store first flipped image data representing the first flipped character 211 in addition to the image data representing the first character 207 in the storage section 45. In that case, however, the capacity of the storage section 45 needs to be increased.

Therefore, in the tape printing apparatus 1 according to the present embodiment, instead of storing the first flipped image data in the storage section 45, the first flipped image data is generated based on the image data representing the first character 207 stored in the storage section 45 through a character flip process, which will be described later.

Character flip is a concept that includes at least one of left-right flip, black-white inversion, or up-down flip. As shown in FIG. 5, the first flipped character 211 includes a first left-right flipped character 211a obtained by flipping the first character 207 left-right, a first black-white inverted character 211b obtained by inverting the first character 207 black-white, a first up-down flipped character 211c obtained by flipping the first character 207 up-down, and the like. The first flipped image data includes first left-right flipped image data representing the first left-right flipped character 211a, first black-white inverted image data representing the first black-white inverted character 211b, first up-down flipped image data representing the first up-down flipped character 211c, and the like.

### Outer Frame Inversion

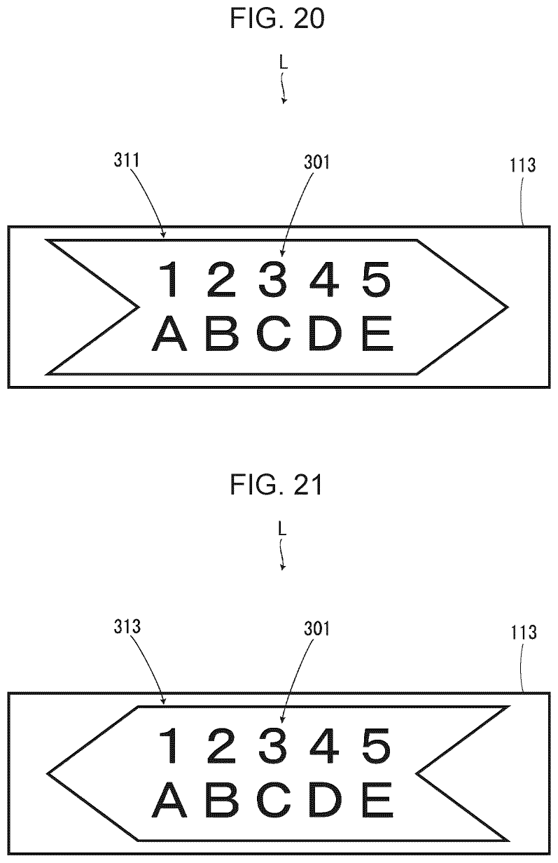

As described above, the tape printing apparatus 1 is capable of printing the non-flipped outer frame 311 as well as the flipped outer frame, that is, the left-right flipped outer frame 313 and the up-down flipped outer frame 315. FIG. 20 is a diagram showing a label L on which the non-flipped outer frame 311 and the text 301 are printed. When the print key 35 is operated while the text screen D4 shown in FIG. 18 is displayed, the tape printing apparatus 1 prints the label L shown in FIG. 20. Further, FIG. 21 is a diagram showing a label L on which the left-right flipped outer frame 313 and the text 301 are printed. A method for printing the label L shown in FIG. 21 will be described later.

As such, since the tape printing apparatus 1 is capable of printing the left-right flipped outer frame 313 and the up-down flipped outer frame 315, it is conceivable to store, in the storage section 45, image data representing the left-right flipped outer frame 313 and image data representing the up-down flipped outer frame 315 in addition to image data representing the non-flipped outer frame 311. Hereinafter, image data representing the non-flipped outer frame 311 will be referred to as “non-flipped image data”, image data representing the left-right flipped outer frame 313 will be referred to as “left-right flipped image data”, and image data representing the up-down flipped outer frame 315 will be referred to as “up-down flipped image data”. In that case, however, the capacity of the storage section 45 needs to be increased. The non-flipped image data is an example of “image data”.

Therefore, in the tape printing apparatus 1 according to the present embodiment, instead of storing left-right flipped image data and up-down flipped image data in the storage section 45, the tape printing apparatus 1 performs an outer frame flip process, which will be described later, thereby generating left-right flipped image data and up-down flipped image data based on the non-flipped image data stored in the storage section 45.

Here, a method for generating left-right flipped image data and up-down flipped image data by the control portion 27 will be described. As shown in FIG. 22, the non-flipped image data representing the non-flipped outer frame 311 is made up of front image data 311a, intermediate image data 311b, and rear image data 311c. The reason why the non-flipped image data is thus made up of three pieces of partial image data is that the length of the intermediate image data 311b changes according to the text 301 disposed within the outer frame. The non-flipped outer frame 311 shown in FIG. 22 is an outer frame that can be subjected to both left-right flip and up-down flip.

When generating left-right flipped image data, the control portion 27 first swaps the order of the front image data 311a and the rear image data 311c, and arranges the image data in the order of the rear image data 311c, the intermediate image data 311b, and the front image data 311a. Thereafter, the control portion 27 performs a process on each of these three pieces of image data, where the bit in the m-th column from the left and the bit in the m-th column from the right in each line are swapped one bit at a time, thereby generating left-right flipped image data.

In addition, when generating up-down flipped image data, the control portion 27 performs a process on each of the front image data 311a, the intermediate image data 311b, and the rear image data 311c, where the bit in the n-th line from the top and the bit in the n-th line from the bottom in each column are swapped one bit at a time, thereby generating up-down flipped image data.

### Selection Procedure for Outer Frame

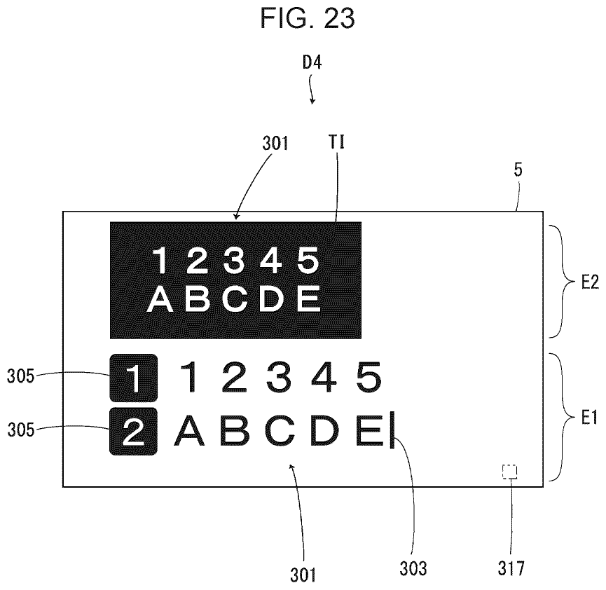

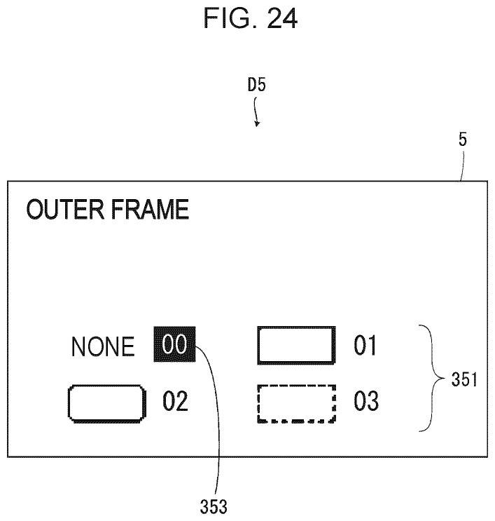

The procedure for printing the label L will be described with reference to the screens shown in FIGS. 23 to 30. FIG. 23 is a diagram showing the text screen D4 on which the text 301 is displayed. The example shown in FIG. 23 shows a state in which two lines of text 301 have been input and the input two lines of text 301 are displayed in the text input area E1 and the print image display area E2. When the first character display key/outer frame key 37 is operated while the text screen D4 shown in FIG. 23 is being displayed, the control portion 27 causes the display portion 5 to display an outer frame selection screen D5 shown in FIG. 24.

As shown in FIG. 24, on the outer frame selection screen D5, a plurality of outer frame candidates 351 respectively corresponding to a plurality of outer frames whose image data are stored in the storage section 45 are displayed. The outer frame candidate 351 includes an outer frame image based on image data and an outer frame number. However, the outer frame candidate 351 including the outer frame number “00” includes the characters “none” in place of the outer frame image. Furthermore, for the outer frame candidate 351 being selected among the plurality of outer frame candidates 351, a selection frame 353 is added to the outer frame number. The selection frame 353 is a solid black frame, and the outer frame number to which the selection frame 353 is added is displayed in white. In this way, the outer frame candidate 351 in a selected state is displayed to be identifiable from the outer frame candidate 351 in a non-selected state.

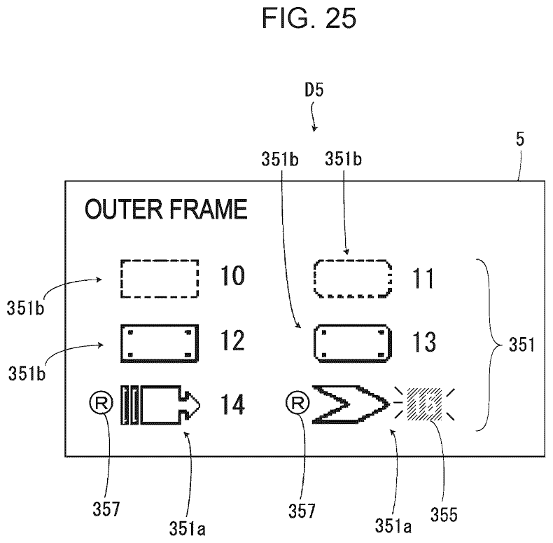

FIG. 25 is a diagram showing a state after the cursor key 31 is operated while the outer frame selection screen D5 shown in FIG. 24 is being displayed. Among the outer frame candidates 351 shown in FIG. 25, an flippable mark 357 with the character “R” enclosed in a circle is added to the outer frame candidate 351 with outer frame number “14” and the outer frame candidate 351 with outer frame number “15”. The flippable mark 357 is an example of an “additional image”. Hereinafter, the outer frame candidate 351 to which the flippable mark 357 is added will be referred to as a “first outer frame candidate 351a”. In addition, the outer frame candidate 351 to which the flippable mark 357 is not added will be referred to as a “second outer frame candidate 351b”.

The flippable mark 357 is a mark indicating that at least one of left-right flip and up-down flip is possible. Therefore, for the outer frame corresponding to the first outer frame candidate 351a to which the flippable mark 357 is added, at least one of the left-right flip flag and the up-down flip flag is set to “1” in the outer frame table 50 of FIG. 19.

In this manner, the control portion 27 receives the selection of one outer frame candidate 351 on the outer frame selection screen D5 on which the outer frame candidates 351, which are candidates for the outer frame, are displayed. In addition, the control portion 27 displays, on the outer frame selection screen D5, the outer frame candidates 351 corresponding to an outer frame that can be subjected to outer frame flip and the outer frame candidate 351 corresponding to an outer frame that cannot be subjected to outer frame flip in different display modes.

The example shown in FIG. 25 shows a state in which the outer frame candidate 351 with outer frame number “15” is provisionally selected. For the provisionally selected outer frame candidate 351, a provisional selection frame 355 is added to the outer frame number, and the outer frame number and the provisional selection frame 355 are displayed in a blinking manner. The provisional selection frame 355 is a shaded frame, and the outer frame number to which the provisional selection frame 355 is added is displayed in white. In this way, the outer frame candidate 351 in a provisionally selected state is displayed to be identifiable from both the outer frame candidate 351 in a selected state and the outer frame candidate 351 in a non-selected state.

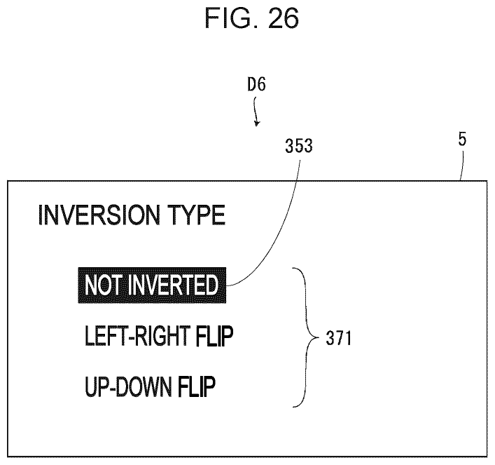

FIG. 26 is a diagram showing an flip type selection screen D6 that is displayed when the selection key 33 is operated while the outer frame selection screen D5 shown in FIG. 25 is being displayed. As shown in FIG. 25, when the first outer frame candidate 351a to which the flippable mark 357 is added is selected on the outer frame selection screen D5, an flip type selection screen D6 is displayed. As will be described later, when a second outer frame candidate 351b to which the flippable mark 357 is not added is selected on the outer frame selection screen D5, the flip type selection screen D6 is not displayed, and instead the text screen D4 is displayed on which the non-flipped outer frame 311 and the text 301 are displayed, as shown in FIG. 30.

The flip type selection screen D6 displays three flip type candidates 371 of “not flipped”, “left-right flip”, and “up-down flip”. When the flip type candidate 371 of “not flipped” is selected, the control portion 27 displays the text screen D4 on which the non-flipped outer frame 311 and the text 301 are displayed, as shown in FIG. 18. Further, when the flip type candidate 371 of “left-right flip” is selected, the control portion 27 displays the text screen D4 on which the left-right flipped outer frame 313 and the text 301 are displayed, as shown in FIG. 28. Further, when the flip type candidate 371 of “up-down flip” is selected, the control portion 27 displays the text screen D4 on which the up-down flipped outer frame 315 and the text 301 are displayed.

However, when the outer frame candidate 351 selected on the outer frame selection screen D5 corresponds to an outer frame that can be subjected to left-right flip but cannot be subjected to up-down flip, the control portion 27 displays the text screen D4 on which the non-flipped outer frame 311 and the text 301 are displayed even when the flip type candidate 371 of “up-down flip” is selected on the flip type selection screen D6. Similarly, when the outer frame candidate 351 selected on the outer frame selection screen D5 corresponds to an outer frame that can be subjected to up-down flip but cannot be subjected to left-right flip, the control portion 27 displays the text screen D4 on which the non-flipped outer frame 311 and the text 301 are displayed even when the flip type candidate 371 of “left-right flip” is selected on the flip type selection screen D6.

Since the outer frame candidate 351 with outer frame number “15” shown in FIG. 25 corresponds to an outer frame that cannot be subjected to up-down flip, when the flip type candidate 371 of “up-down flip” is selected on the flip type selection screen D6, the text screen D4 is displayed on which the non-flipped outer frame 311 and the text 301 are displayed, as shown in FIG. 18.

The example shown in FIG. 26 shows a state in which the flip type candidate 371 of “not flipped” is selected. The selection frame 353 is added to the selected flip type candidate 371. In this way, the flip type candidate 371 in a selected state is displayed to be identifiable from the flip type candidate 371 in a non-selected state.

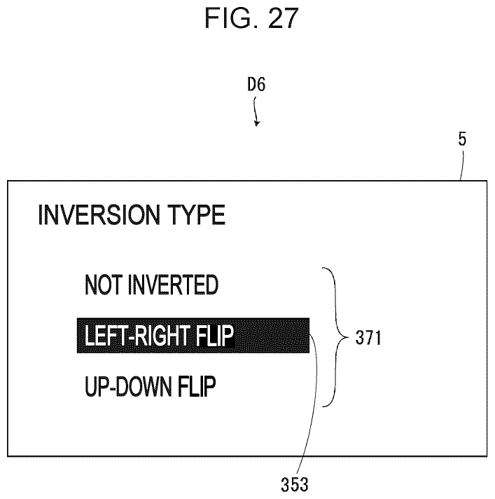

FIG. 27 is a diagram showing a state in which the cursor key 31 is operated while the flip type selection screen D6 shown in FIG. 26 is displayed, and the flip type candidate 371 of “left-right flip” is selected. In this state, when the selection key 33 is operated, the text screen D4 shown in FIG. 28 is displayed.

When the outer frame candidate 351 selected on the outer frame selection screen D5 corresponds to an outer frame that can be subjected to left-right flip, and the flip type candidate 371 of “left-right flip” is selected on the flip type selection screen D6, the left-right flipped outer frame 313 and the text 301 are displayed in the print image display area E2, as shown in FIG. 28. Furthermore, since the left-right flipped outer frame 313 is displayed in the print image display area E2, the flip indicator 317 is displayed in a lit manner.

In this way, when the outer frame candidate 351 corresponding to an outer frame that can be subjected to outer frame flip is selected on the outer frame selection screen D5, the control portion 27 causes the display portion 5 to display the flip type selection screen D6. In addition, the control portion 27 receives the selection of the flip type candidate 371 on the flip type selection screen D6, and controls the display portion 5 such that the left-right flipped outer frame 313 or the up-down flipped outer frame 315, which has been subjected to outer frame flip according to the selected flip type candidate 371, and the text 301 are displayed on the text screen D4. In addition, when the control portion 27 receives the selection of the flip type candidate 371 of “left-right flip” or “up-down flip” on the flip type selection screen D6, it generates left-right flipped image data or up-down flipped image data based on the image data of the outer frame corresponding to the outer frame candidate 351 selected on the outer frame selection screen D5. In addition, the control portion 27 controls the display portion 5 such that an flipped outer frame based on the generated left-right flipped image data or up-down flipped image data and text 301 disposed within the flipped outer frame without either left-right flip or up-down flip are displayed on the text screen D4.

When the print key 35 is operated in the state shown in FIG. 28, the label L is created on which the left-right flipped outer frame 313 and the text 301 are printed, as shown in FIG. 21.

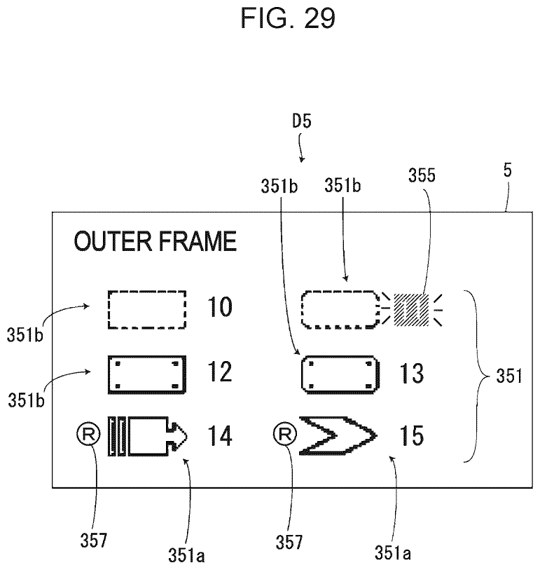

FIG. 29 is a diagram showing a state in which the outer frame candidate 351 with outer frame number “11”, which is the second outer frame candidate 351b to which the flippable mark 357 is not added, is provisionally selected on the outer frame selection screen D5. In this state, when the selection key 33 is operated, the text screen D4 shown in FIG. 30 is displayed.

When the second outer frame candidate 351b is selected on the outer frame selection screen D5, the non-flipped outer frame 311 and the text 301 are displayed in the print image display area E2, as shown in FIG. 30. Furthermore, since the flipped outer frame is not displayed in the print image display area E2, the flip indicator 317 is displayed in an unlit manner.

### Editing and Printing Process

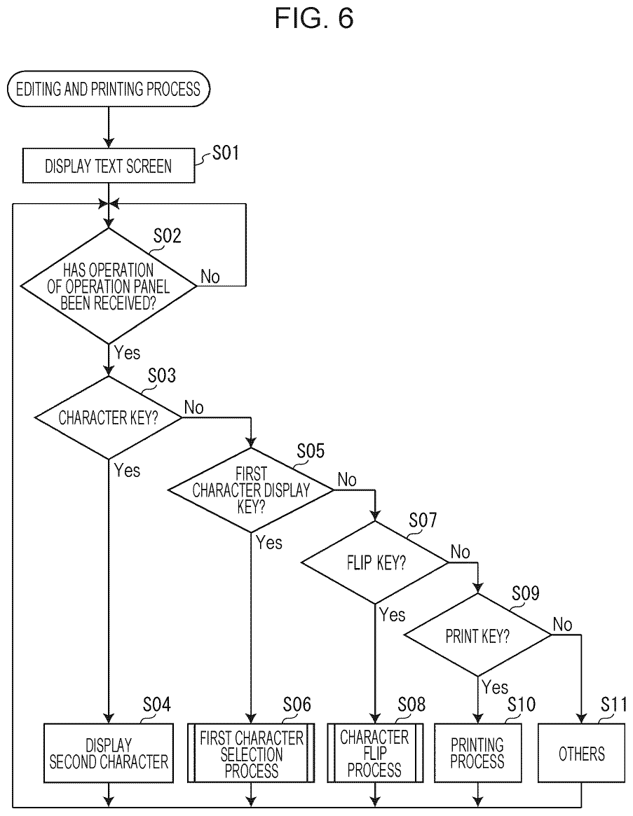

The editing and printing process executed by the control portion 27 will be described with reference to FIG. 6. The control portion 27 performs the editing and printing process by the processor 43 executing the program for the editing and printing process stored in the storage section 45. The control portion 27 starts the editing and printing process, for example, when the power is turned on.

In step S01, the control portion 27 causes the display portion 5 to display a text screen D1.

In step S02, the control portion 27 determines whether or not an operation of the operation panel 3 by the user, that is, an operation on one of the various keys provided on the operation panel 3, has been received. When the control portion 27 determines that an operation of the operation panel 3 by the user has been received, the process proceeds to step S03.

When the control portion 27 determines in step S02 that the operation of the operation panel 3 by the user has not been received, the control portion 27 repeats step S02.

In step S03, the control portion 27 determines whether or not the key operated by the user is the character key 29. When the control portion 27 determines that the key operated by the user is the character key 29, the process proceeds to step S04.

In step S04, the control portion 27 causes the second character 209 corresponding to the character key 29 operated by the user to be displayed on the text screen D1 at the position of the cursor 203 at the point in time when the character key 29 was operated. That is, the control portion 27 reads out image data corresponding to the character key 29 operated by the user from the storage section 45, and controls the display portion 5 based on the read out image data. As a result, the second character 209 corresponding to the character key 29 operated by the user is displayed on the text screen D1 as a character constituting the text 201 to be printed. After executing step S04, the control portion 27 returns to step S02.

In step S03, when the control portion 27 determines that the key operated by the user is not the character key 29, the process proceeds to step S05.

In step S05, the control portion 27 determines whether or not the key operated by the user is the first character display key/outer frame key 37. When the control portion 27 determines that the key operated by the user is the first character display key/outer frame key 37, the process proceeds to step S06.

In step S06, the control portion 27 executes a first character selection process, which will be described later. After executing step S06, the control portion 27 returns to step S02.

In step S05, when the control portion 27 determines that the key operated by the user is not the first character display key/outer frame key 37, the process proceeds to step S07.

In step S07, the control portion 27 determines whether or not the key operated by the user is the flip key 41. When the control portion 27 determines that the key operated by the user is the flip key 41, the process proceeds to step S08. That is, the control portion 27 receives the operation of the flip key 41 of the user as an flip instruction to display the first flipped character 211 on the text screen D1 in place of the first character 207.

In step S08, the control portion 27 executes a character flip process, which will be described later. After executing step S08, the control portion 27 returns to step S02.

In step S07, when the control portion 27 determines that the key operated by the user is not the flip key 41, the process proceeds to step S09.

In step S09, the control portion 27 determines whether or not the key operated by the user is the print key 35. When the control portion 27 determines that the key operated by the user is the print key 35, the process proceeds to step S10.

In step S10, the control portion 27 executes a printing process. That is, based on the result of editing the text 201 on the text screen D1, the control portion 27 reads out image data of each character constituting the text 201 from the storage section 45, and generates print data based on the read out image data. The control portion 27 controls the print head 11, the feed motor 21, and the cutter motor 23 based on the generated print data. Accordingly, the text 201 edited on the text screen D1 is printed on the tape 113 and the label L is created. For example, when printing is performed based on the results of editing the text 201 on the text screen D1 shown in FIG. 2, the label L is created on which the first character 207 is printed, as shown in FIG. 16. After executing step S10, the control portion 27 returns to step S02.

In step S09, when the control portion 27 determines that the key operated by the user is not the print key 35, the process proceeds to step S11.

In step S11, the control portion 27 executes other processes according to the operated key. The other processes include, for example, kana-kanji conversion processes. After executing step S11, the control portion 27 returns to step S02.

### First Character Selection Process

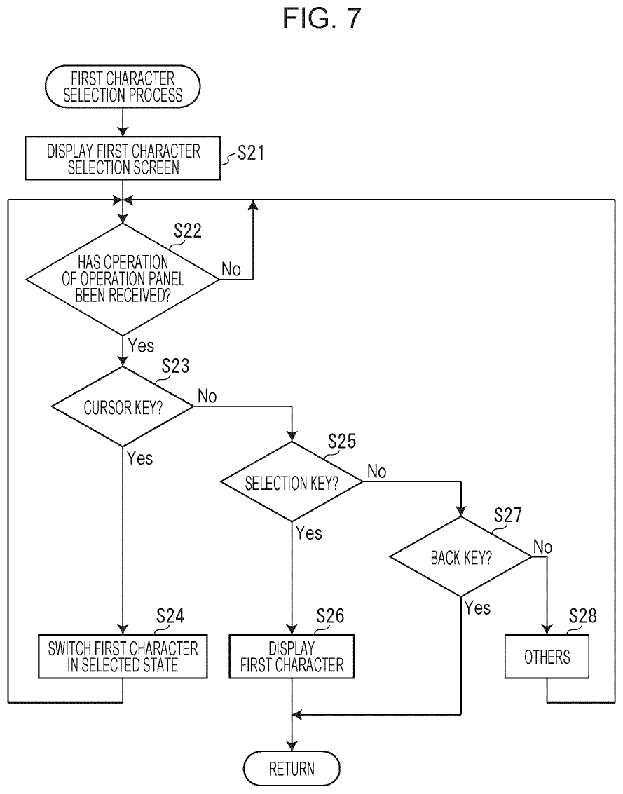

A first character selection process will be described with reference to FIG. 7. In step S21, the control portion 27 causes the display portion 5 to display a first character selection screen D2. On the first character selection screen D2, a plurality of first characters 207 are displayed. One of the plurality of first characters 207 is in a selected state. The first character 207 in a selected state is displayed to be identifiable from the first character 207 in a non-selected state. In FIG. 8, the first character 207 in the selected state is shown with a character surrounding line 213. Note that instead of drawing the character surrounding line 213 around the first character 207 in the selected state, the first character 207 in the selected state may be displayed in black-white inversion or in a blinking manner.

In step S22, the control portion 27 determines whether or not an operation of the operation panel 3 by the user has been received. When the control portion 27 determines that an operation of the operation panel 3 by the user has been received, the process proceeds to step S23.

When the control portion 27 determines in step S22 that the operation of the operation panel 3 by the user has not been received, the control portion 27 repeats step S22.

In step S23, the control portion 27 determines whether or not the key operated by the user is the cursor key 31. When the control portion 27 determines that the key operated by the user is the cursor key 31, the process proceeds to step S24.

In step S24, the control portion 27 switches the first character 207 in the selected state from one first character 207 to another first character 207 in accordance with the direction in which the cursor key 31 is operated. That is, the first character 207 with the character surrounding line 213 is switched from one first character 207 to another first character 207. After executing step S24, the control portion 27 returns to step S22.

In step S23, when the control portion 27 determines that the key operated by the user is not the cursor key 31, the process proceeds to step S25.

In step S25, the control portion 27 determines whether or not the key operated by the user is the selection key 33. When the control portion 27 determines that the key operated by the user is the selection key 33, the process proceeds to step S26. The control portion 27 receives the operation of the selection key 33 while the first character selection screen D2 is displayed as a selection of one first character 207 from among the plurality of first characters 207 on the first character selection screen D2.

In step S26, the control portion 27 causes the selected first character 207, that is, the first character 207 that was in a selected state at the point in time when the selection key 33 was operated, to be displayed on the text screen D1. That is, the control portion 27 reads out image data corresponding to the selected first character 207 from the storage section 45, and controls the display portion 5 based on the read out image data. As a result, the first character selection screen D2 is switched to the text screen D1, and the first character 207 selected on the first character selection screen D2 is displayed on the text screen D1 as a character that constitutes the text 201 to be printed. After executing step S26, the control portion 27 returns to the editing and printing process of FIG. 6.

In step S25, when the control portion 27 determines that the key operated by the user is not the selection key 33, the process proceeds to step S27.

In step S27, the control portion 27 determines whether or not the key operated by the user is the back key 39. When the control portion 27 determines that the key operated by the user is the back key 39, the process returns to the editing and printing process of FIG. 6.

In step S27, when the control portion 27 determines that the key operated by the user is not the back key 39, the process proceeds to step S28.

In step S28, the control portion 27 executes other processes according to the operated key. After executing step S28, the control portion 27 returns to step S22.

### Character Inversion Process

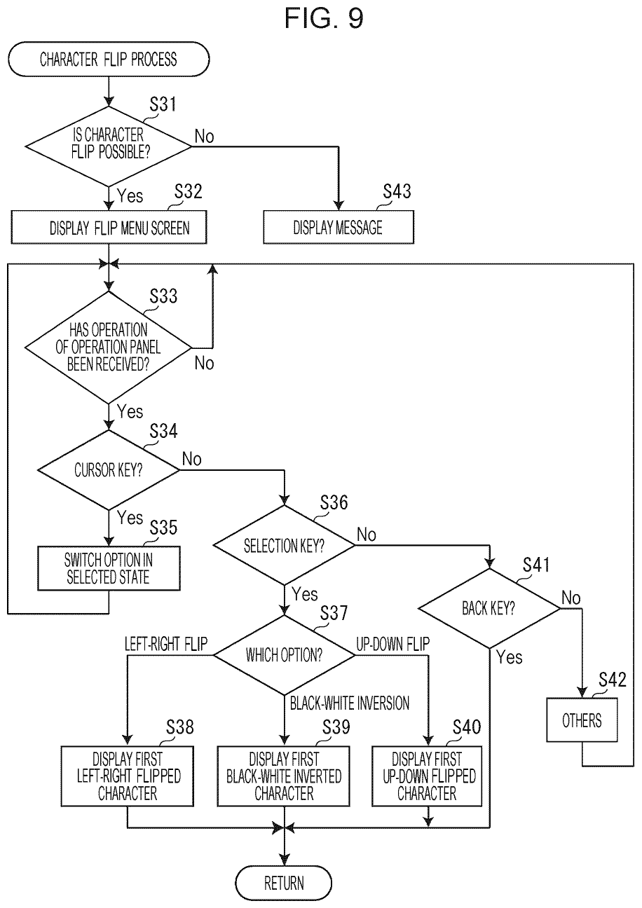

A character flip process will be described with reference to FIG. 9. In step S31, the control portion 27 determines whether or not the character to be the target of character flip can be subjected to character flip. At the point in time when the control portion 27 receives an flip instruction, that is, the point in time when the flip key 41 was operated, the control portion 27 sets the character on which the cursor 203 is positioned in the text screen D1, for example the character to the left of the cursor 203, as the target of character flip. Accordingly, it is possible to easily switch the first character 207 to be the target of character flip by moving the cursor 203. The control portion 27 refers to the character table 47, and when at least one of the left-right flip flag, the black-white inversion flag, and the up-down flip flag corresponding to the character to be the target of character flip is “1: permitted”, the control portion 27 determines that the character can be subjected to character flip. Furthermore, when the left-right flip flag, the black-white inversion flag, and the up-down flip flag corresponding to the character to be the target of character flip are all set to “2: prohibited”, the control portion 27 determines that the character cannot be subjected to character flip. When the control portion 27 determines that the character to be the target of character c flip an be subjected to character flip, the process proceeds to step S32.

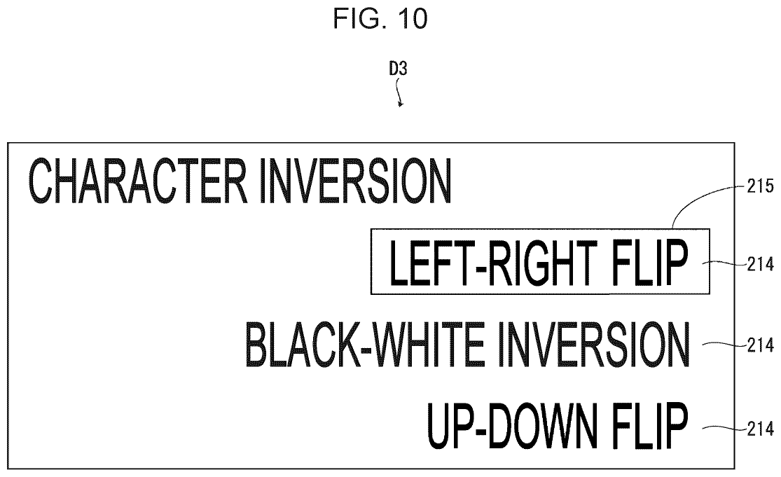

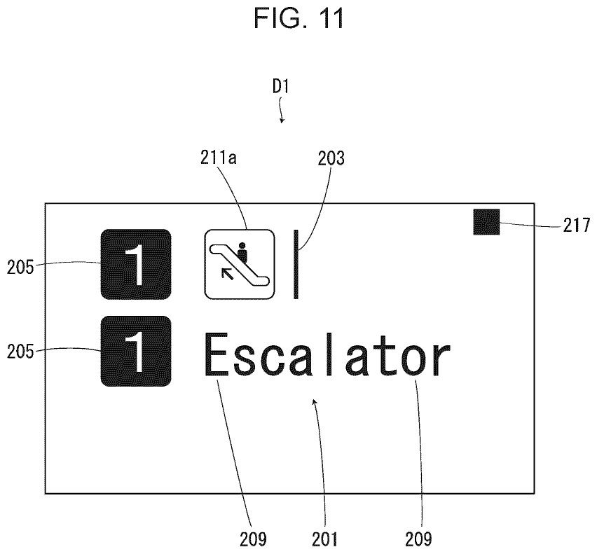

In step S32, the control portion 27 causes the display portion 5 to display an flip menu screen D3. Inversion options 214 are displayed on the menu screen D3. The flip options 214 include “left-right flip”, “black-white inversion” and “up-down flip”. One flip option 214 among the plurality of flip options 214 is in a selected state. The flip option 214 in the selected state is displayed to be identifiable from the flip options 214 in a non-selected state. In FIG. 10, the flip option 214 in the selected state is shown with an option surrounding line 215. Note that instead of drawing the option surrounding line 215 around the flip option 214 in the selected state, the flip option 214 in the selected state may be displayed in black-white inversion or in a blinking manner.

In step S33, the control portion 27 determines whether or not an operation of the operation panel 3 by the user has been received. When the control portion 27 determines that an operation of the operation panel 3 by the user has been received, the process proceeds to step S34.

When the control portion 27 determines in step S33 that the operation of the operation panel 3 by the user has not been received, the control portion 27 repeats step S33.

In step S34, the control portion 27 determines whether or not the key operated by the user is the cursor key 31. When the control portion 27 determines that the key operated by the user is the cursor key 31, the process proceeds to step S35.

In step S35, the control portion 27 switches the flip option 214 in the selected state from one flip option 214 to another flip option 214 in accordance with the direction in which the cursor key 31 is operated. That is, the flip option 214 with the option surrounding line 215 is switched from one flip option 214 to another flip option 214. After executing step S35, the control portion 27 returns to step S33.

In step S34, when the control portion 27 determines that the key operated by the user is not the cursor key 31, the process proceeds to step S36.

In step S36, the control portion 27 determines whether or not the key operated by the user is the selection key 33. When the control portion 27 determines that the key operated by the user is the selection key 33, the process proceeds to step S37.

In step S37, the control portion 27 determines whether the selected flip option 214, that is, the flip option 214 that was in a selected state at the point in time when the selection key 33 was operated, is “left-right flip”, “black-white inversion” or “up-down flip”. When the control portion 27 determines that the selected flip option 214 is “left-right flip”, the process proceeds to step S38. When the control portion 27 determines that the selected flip option 214 is “black-white inversion”, the process proceeds to step S39. When the control portion 27 determines that the selected flip option 214 is “up-down flip”, the process proceeds to step S40.

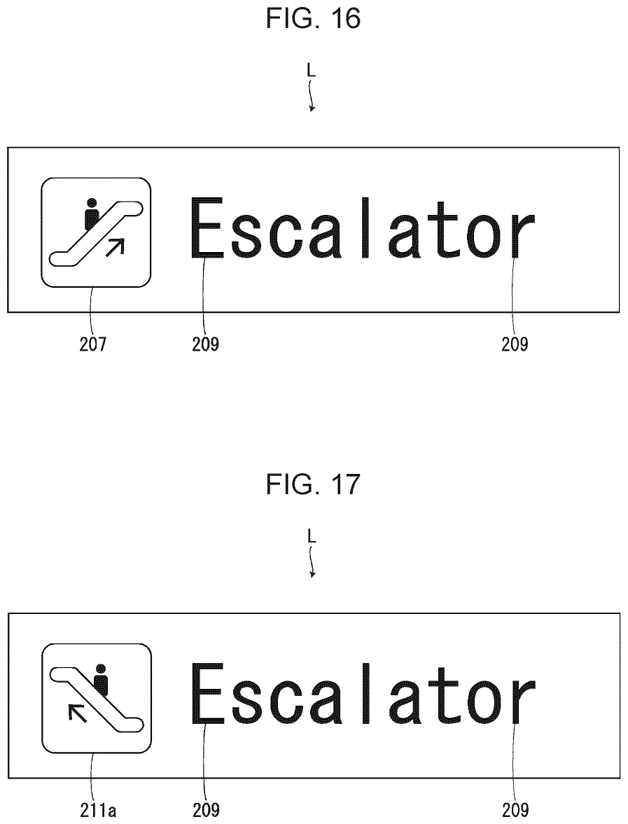

In step S38, the control portion 27 causes the first left-right flipped character 211a to be displayed on the text screen D1 in place of the first character 207 that is the target of character flip. That is, the control portion 27 generates first left-right flipped image data representing the first left-right flipped character 211a based on image data representing the first character 207 that is the target of character flip. For example, the control portion 27 performs a process on the image data representing the first character 207 such that the bit in the m-th column from the left and the bit in the m-th column from the right in each line are swapped, thereby generating first left-right flipped image data. The control portion 27 controls the display portion 5 based on the generated first left-right flipped image data. As a result, on the text screen D1 switched from the flip menu screen D3, the first left-right flipped character 211a is displayed as a character constituting the text 201 to be printed, in place of the first character 207. After executing step S38, the control portion 27 returns to the editing and printing process of FIG. 6. Subsequently, when the print key 35 is operated, a label L is created on which the first left-right flipped character 211a is printed, as shown in FIG. 17.

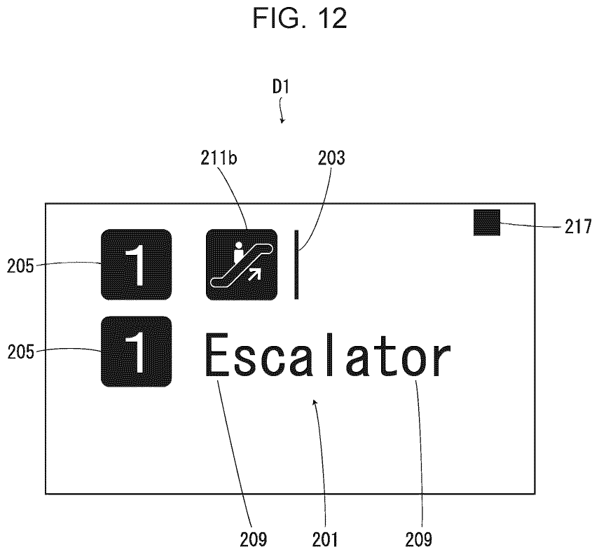

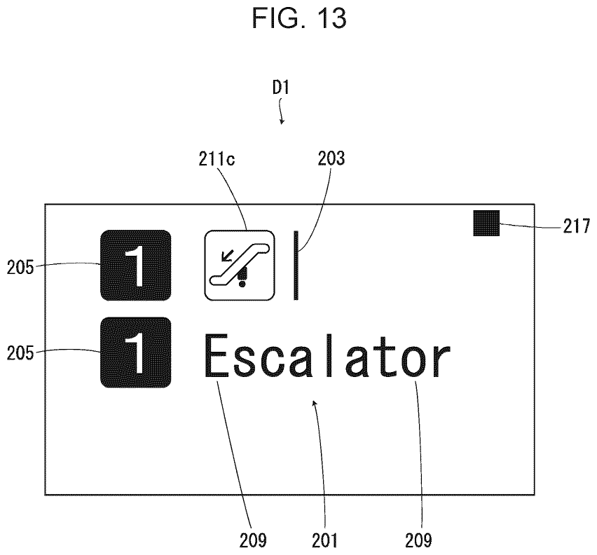

In step S39, the control portion 27 causes the first black-white inverted character 211b to be displayed on the text screen D1 in place of the first character 207 that is the target of character flip. That is, the control portion 27 generates first black-white inverted image data representing the first black-white inverted character 211b based on image data representing the first character 207 that is the target of character flip. For example, the control portion 27 performs a process on the image data representing the first character 207 such that the bit of “1” is replaced with the bit of “0” and the bit of “0” is replaced with the bit of “1”, thereby generating first black-white inverted image data. The bit of “1” represents black, and the bit of “0” represents white. As a result, on the text screen D1 switched from the flip menu screen D3, the first black-white inverted character 211b is displayed as a character constituting the text 201 to be printed, in place of the first character 207 (see FIG. 12). After executing step S39, the control portion 27 returns to the editing and printing process of FIG. 6.

In step S40, the control portion 27 causes the first up-down flipped character 211c to be displayed on the text screen D1 in place of the first character 207 that is the target of character flip. That is, the control portion 27 generates first up-down flipped image data representing the first up-down flipped character 211c based on image data representing the first character 207 that is the target of character flip. For example, the control portion 27 generates the first up-down flipped image data by swapping the bit in the n-th line from the top and the bit in the n-th line from the bottom in each column for the image data representing the first character 207. As a result, on the text screen D1 switched from the flip menu screen D3, the first up-down flipped character 211c is displayed as a character constituting the text 201 to be printed, in place of the first character 207. After executing step S40, the control portion 27 returns to the editing and printing process of FIG. 6.

When the control portion 27 receives a command that the print key 35 has been operated while the first left-right flipped character 211a is displayed on the text screen D1 (step S09: Yes), the control portion 27 generates first left-right flipped image data in the same manner as in step S38, and generates print data based on the generated first left-right flipped image data. The same applies to a case where the control portion 27 receives a command that the print key 35 has been operated while the first black-white inverted character 211b or the first up-down flipped character 211c is displayed on the text screen D1.

In addition, as shown in FIG. 2 and the like, an flip indicator 217 is provided on the text screen D1. Although not shown, a word meaning “flip” is written on the edge portion of the display portion 5 at a position corresponding to the flip indicator 217. When the cursor 203 is positioned on the first flipped character 211, the control portion 27 turns on the flip indicator 217. When the cursor 203 is positioned on a character other than the first flipped character 211, the control portion 27 turns off the flip indicator 217. By looking at the flip indicator 217, the user can easily identify whether or not the character on which the cursor 203 is positioned is the first flipped character 211. In FIG. 2 and the like, the flip indicator 217 is displayed in the upper right corner of the text screen D1, but the display position of the flip indicator 217 is not limited to the upper right corner of the text screen D1.

In step S36, when the control portion 27 determines that the key operated by the user is not the selection key 33, the process proceeds to step S41.

In step S41, the control portion 27 determines whether or not the key operated by the user is the back key 39. When the control portion 27 determines that the key operated by the user is the back key 39, the process returns to the editing and printing process of FIG. 6.

In step S41, when the control portion 27 determines that the key operated by the user is not the back key 39, the process proceeds to step S42.

In step S42, the control portion 27 executes other processes according to the operated key. After executing step S42, the control portion 27 returns to step S33.

In step S31, when the control portion 27 determines that the character to be the target of character flip cannot be subjected to character flip, the process proceeds to step S43.

In step S43, the control portion 27 causes the display portion 5 to display a message indicating that the character to be the target of character flip cannot be subjected to character flip. Accordingly, it is possible to notify the user that the character to be the target of character flip cannot be subjected to character flip. At this time, the display portion 5 functions as a notification portion that notifies the user that the character to be the target of character flip cannot be subjected to character flip.

### Editing and Printing Process

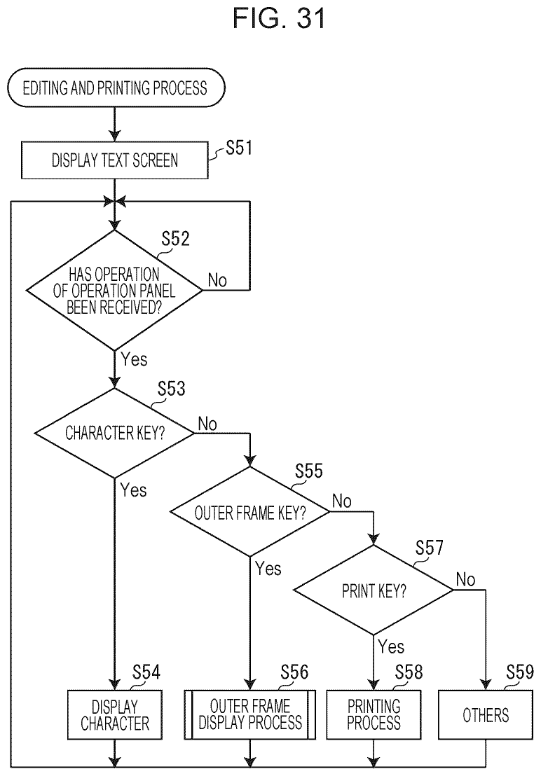

An editing and printing process executed by the control portion 27 will be described with reference to FIG. 31. The control portion 27 performs the editing and printing process by the processor 43 executing the program for the editing and printing process stored in the storage section 45. The control portion 27 starts the editing and printing process, for example, when the power is turned on.

In step S51, the control portion 27 causes the display portion 5 to display a text screen D4, as shown in FIG. 23.

In step S52, the control portion 27 determines whether or not an operation of the operation panel 3 by the user, that is, an operation on one of the various keys provided on the operation panel 3, has been received. When the control portion 27 determines that an operation of the operation panel 3 by the user has been received, the process proceeds to step S53.

When the control portion 27 determines in step S52 that the operation of the operation panel 3 by the user has not been received, the control portion 27 repeats step S52.

In step S53, the control portion 27 determines whether or not the key operated by the user is the character key 29. When the control portion 27 determines that the key operated by the user is the character key 29, the process proceeds to step S54.

In step S54, the control portion 27 causes the text 301 corresponding to the character key 29 operated by the user to be displayed in the text input area E1 and the print image display area E2 of the text screen D4. After executing step S54, the control portion 27 returns to step S52.

In step S53, when the control portion 27 determines that the key operated by the user is not the character key 29, the process proceeds to step S55.

In step S55, the control portion 27 determines whether or not the key operated by the user is the first character display key/outer frame key 37. When the control portion 27 determines that the key operated by the user is the first character display key/outer frame key 37, the process proceeds to step S56.

In step S56, the control portion 27 executes an outer frame display process, which will be described later. After executing step S56, the control portion 27 returns to step S52.

In step S55, when the control portion 27 determines that the key operated by the user is not the first character display key/outer frame key 37, the process proceeds to step S57.

In step S57, the control portion 27 determines whether or not the key operated by the user is the print key 35. When the control portion 27 determines that the key operated by the user is the print key 35, the process proceeds to step S58.

In step S58, the control portion 27 executes a printing process. That is, the control portion 27 generates print data based on the editing results of the text screen D4, and controls the print head 11, the feed motor 21, and the cutter motor 23 based on the generated print data. Accordingly, a label L is created that corresponds to the print image displayed in the print image display area E2 of the text screen D4.

In step S57, when the control portion 27 determines that the key operated by the user is not the print key 35, the process proceeds to step S59.

In step S59, the control portion 27 executes other processes according to the operated key. The other processes include, for example, symbol input processes and kana-kanji conversion processes. After executing step S59, the control portion 27 returns to step S52.

### Outer Frame Display Process

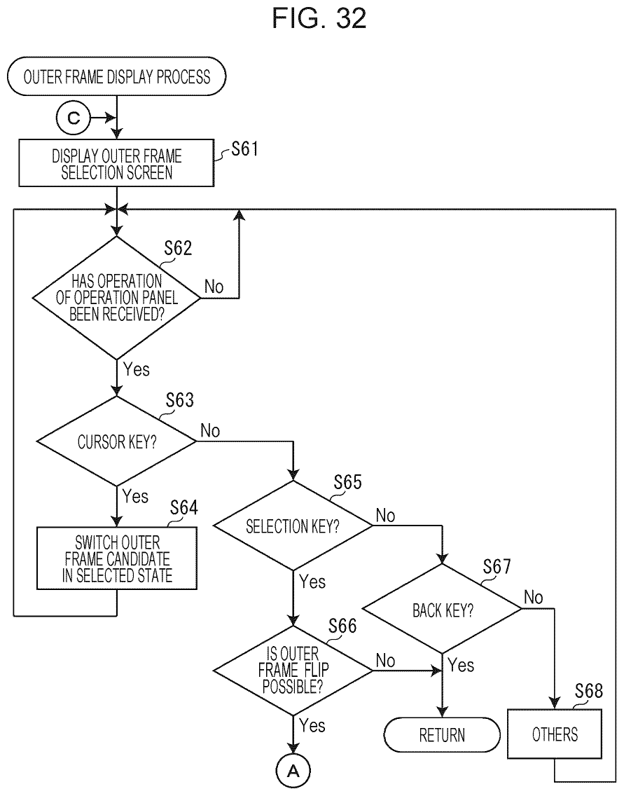

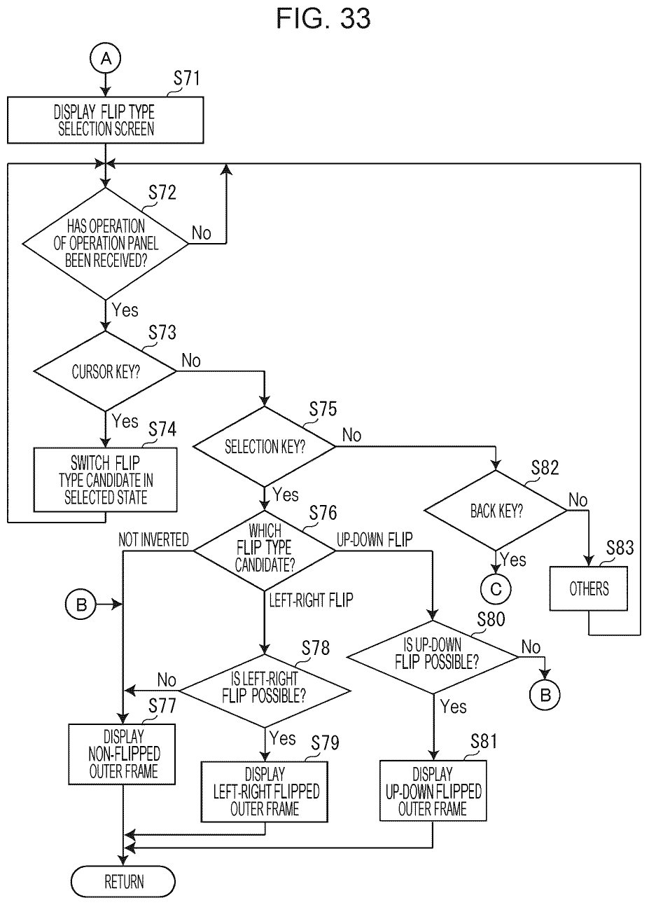

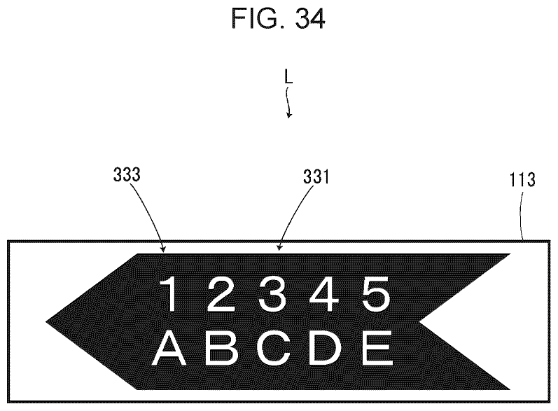

An outer frame display process will be described with reference to FIGS. 32 and 33. In step S61, the control portion 27 causes the display portion 5 to display the outer frame selection screen D5 as shown in FIG. 24.

In step S62, the control portion 27 determines whether or not an operation of the operation panel 3 by the user has been received. When the control portion 27 determines that an operation of the operation panel 3 by the user has been received, the process proceeds to step S63.

When the control portion 27 determines in step S62 that the operation of the operation panel 3 by the user has not been received, the control portion 27 repeats step S62.

In step S63, the control portion 27 determines whether or not the key operated by the user is the cursor key 31. When the control portion 27 determines that the key operated by the user is the cursor key 31, the process proceeds to step S64.

In step S64, the control portion 27 switches the outer frame candidate 351 in the selected state from one outer frame candidate 351 to another outer frame candidate 351 in accordance with the direction in which the cursor key 31 is operated. After executing step S64, the control portion 27 returns to step S62.

In step S63, when the control portion 27 determines that the key operated by the user is not the cursor key 31, the process proceeds to step S65.

In step S65, the control portion 27 determines whether or not the key operated by the user is the selection key 33. When the control portion 27 determines that the key operated by the user is the selection key 33, the process proceeds to step S66. The control portion 27 receives the operation of the selection key 33 while the outer frame selection screen D5 is displayed as a selection of an outer frame candidate 351 on the outer frame selection screen D5.

In step S66, the control portion 27 determines whether or not the outer frame corresponding to the outer frame candidate 351 selected by the user can be subjected to outer frame flip. When the control portion 27 determines that the outer frame corresponding to the outer frame candidate 351 selected by the user can be subjected to outer frame flip, the process proceeds to step S71 in FIG. 33.

In step S66, when the control portion 27 determines that the outer frame corresponding to the outer frame candidate 351 selected by the user cannot be subjected to outer frame flip, the process returns to the editing and printing process of FIG. 31. In this case, the control portion 27 displays the non-flipped outer frame 311 corresponding to the outer frame candidate 351 selected by the user in the print image display area E2 of the text screen D4.

Note that the operation of the first character display key/outer frame key 37 and the selection of the outer frame candidate 351 on the outer frame selection screen D5 that corresponds to an outer frame that cannot be subjected to outer frame flip are examples of an “input of a non-flipped outer frame”.

In step S65, when the control portion 27 determines that the key operated by the user is not the selection key 33, the process proceeds to step S67.

In step S67, the control portion 27 determines whether or not the key operated by the user is the back key 39. When the control portion 27 determines that the key operated by the user is the back key 39, the process returns to the editing and printing process of FIG. 31.

In step S67, when the control portion 27 determines that the key operated by the user is not the back key 39, the process proceeds to step S68.

In step S68, the control portion 27 executes other processes according to the operated key. After executing step S68, the control portion 27 returns to step S62.

In step S71 in FIG. 33, the control portion 27 causes the display portion 5 to display the flip type selection screen D6 as shown in FIG. 26.

In step S72, the control portion 27 determines whether or not an operation of the operation panel 3 by the user has been received. When the control portion 27 determines that an operation of the operation panel 3 by the user has been received, the process proceeds to step S73.

When the control portion 27 determines in step S72 that the operation of the operation panel 3 by the user has not been received, the control portion 27 repeats step S72.

In step S73, the control portion 27 determines whether or not the key operated by the user is the cursor key 31. When the control portion 27 determines that the key operated by the user is the cursor key 31, the process proceeds to step S74.

In step S74, the control portion 27 switches the flip type candidate 371 in the selected state from one flip type candidate 371 to another flip type candidate 371 in accordance with the direction in which the cursor key 31 is operated. After executing step S74, the control portion 27 returns to step S72.

In step S73, when the control portion 27 determines that the key operated by the user is not the cursor key 31, the process proceeds to step S75.

In step S75, the control portion 27 determines whether or not the key operated by the user is the selection key 33. When the control portion 27 determines that the key operated by the user is the selection key 33, the process proceeds to step S76. The control portion 27 receives the operation of the selection key 33 while the flip type selection screen D6 is displayed as a selection of an flip type candidate 371 on the flip type selection screen D6.

In step S76, the control portion 27 determines whether the selected flip type candidate 371, that is, the flip type candidate 371 that was in a selected state at the point in time when the selection key 33 was operated, is “not flipped”, “left-right flip”, or “up-down flip”. When the control portion 27 determines that the selected flip type candidate 371 is “not flipped”, the process proceeds to step S77. When the control portion 27 determines that the selected flip type candidate 371 is “left-right flip”, the process proceeds to step S78. When the control portion 27 determines that the selected flip type candidate 371 is “up-down flip”, the process proceeds to step S80.

In step S77, the control portion 27 causes the non-flipped outer frame 311 corresponding to the outer frame candidate 351 that was in the selected state at the point in time when the selection key 33 was operated in step S65 of FIG. 32 to be displayed in the print image display area E2 of the text screen D4. That is, the control portion 27 causes the non-flipped outer frame 311 based on image data representing the selected outer frame to be displayed in the print image display area E2. After executing step S77, the control portion 27 returns to the editing and printing process of FIG. 31.

In step S78, the control portion 27 determines whether or not the outer frame corresponding to the outer frame candidate 351 that was in the selected state at the point in time when the selection key 33 was operated in step S65 of FIG. 32 can be subjected to left-right flip. When the control portion 27 determines that left-right flip is possible, the process proceeds to step S79. When the control portion 27 determines that left-right flip is not possible, the process proceeds to step S77.

In step S79, the control portion 27 causes the left-right flipped outer frame 313, which is a left-right flipped outer frame corresponding to the outer frame candidate 351 that was in the selected state at the point in time when the selection key 33 was operated in step S65 of FIG. 32, to be displayed in the print image display area E2 of the text screen D4. That is, the control portion 27 generates left-right flipped image data based on the image data representing the selected outer frame, and causes the left-right flipped outer frame 313 based on the generated left-right flipped image data to be displayed in the print image display area E2. After executing step S79, the control portion 27 returns to the editing and printing process of FIG. 31.

In step S80, the control portion 27 determines whether or not the outer frame corresponding to the outer frame candidate 351 that was in the selected state at the point in time when the selection key 33 was operated in step S65 of FIG. 32 can be subjected to up-down flip. When the control portion 27 determines that up-down flip is possible, the process proceeds to step S81. When the control portion 27 determines that up-down flip is not possible, the process proceeds to step S77.

In step S81, the control portion 27 causes the up-down flipped outer frame 315, which is an up-down flipped outer frame corresponding to the outer frame candidate 351 that was in the selected state at the point in time when the selection key 33 was operated in step S65 of FIG. 32, to be displayed in the print image display area E2 of the text screen D4. That is, the control portion 27 generates up-down flipped image data based on the image data representing the selected outer frame, and causes the up-down flipped outer frame 315 based on the generated up-down flipped image data to be displayed in the print image display area E2. After executing step S81, the control portion 27 returns to the editing and printing process of FIG. 31.

Note that the operation of the first character display key/outer frame key 37, the selection of the outer frame candidate 351 on the outer frame selection screen D5, and the selection of the flip type candidate 371 of “not flipped” on the flip type selection screen D6 are examples of an “input of a non-flipped outer frame”. In addition, the operation of the first character display key/outer frame key 37, the selection of the outer frame candidate 351 on the outer frame selection screen D5, and the selection of the flip type candidate 371 of “left-right flip” or “up-down” flip on the flip type selection screen D6 are examples of an “input of an flipped outer frame”.

In step S75, when the control portion 27 determines that the key operated by the user is not the selection key 33, the process proceeds to step S82.

In step S82, the control portion 27 determines whether or not the key operated by the user is the back key 39. When the control portion 27 determines that the key operated by the user is the back key 39, the process returns to step S61 in FIG. 32.

In step S82, when the control portion 27 determines that the key operated by the user is not the back key 39, the process proceeds to step S83.

In step S83, the control portion 27 executes other processes according to the operated key. After executing step S83, the control portion 27 returns to step S72.

As described above, the tape printing apparatus 1 according to the present embodiment includes the display portion 5 and the control portion 27. The control portion 27 includes the storage section 45. The storage section 45 stores image data representing characters. The control portion 27 receives the selection of one first character 207 from among the plurality of first characters 207 on the first character selection screen D2 displayed on the display portion 5. The control portion 27 controls the display portion 5 based on image data representing the selected first character 207 such that the selected first character 207 is displayed on the text screen D1 as a character that constitutes the text 201 to be printed. The control portion 27 receives an flip instruction to display the first flipped character 211 in which the first character 207 is subjected to character flip, on the text screen D1 in place of the first character 207. When the control portion 27 receives the flip instruction, the control portion 27 generates first flipped image data representing the first flipped character 211 based on the image data representing the first character 207. The control portion 27 controls the display portion 5 based on the generated first flipped image data such that the first flipped character 211 is displayed on the text screen D1 as a character that constitutes the text 201 in place of the first character 207.

According to this configuration, the first flipped character 211 can be displayed in place of the first character 207 as a character constituting the text 201 on the text screen D1 without storing the first flipped image data in the storage section 45 in advance. Therefore, it is possible to increase the number of printable character designs without increasing the capacity of the storage section 45.

As described above, the tape printing apparatus 1 according to the present embodiment includes the display portion 5 and the control portion 27 having the storage section 45 that stores image data representing the outer frame to be printed on the tape 113. The control portion 27 receives an input of text 301 to be disposed within the outer frame and printed on the tape 113, an input of a non-flipped outer frame 311 based on image data as the outer frame, and an input of an flipped outer frame in which the entire non-flipped outer frame 311 is subjected to outer frame flip including at least one of left-right flip and up-down flip, as the outer frame. When the control portion 27 receives an input of the flipped outer frame, the control portion 27 generates flipped image data representing the flipped outer frame based on the image data, and controls the display portion 5 such that the flipped outer frame based on the generated flipped image data and the text 301 disposed within the flipped outer frame without either left-right flip or up-down flip are displayed.

In this way, the tape printing apparatus 1 can display the flipped outer frame on the display portion 5 without storing image data representing the flipped outer frame in the storage section 45 in advance. Therefore, it is possible to increase the number of printable outer frame designs without increasing the capacity of the storage section 45.

In addition, on the outer frame selection screen D5, the control portion 27 displays the outer frame candidate 351 corresponding to an outer frame that can be subjected to outer frame flip with the flipped mark 357 added, and displays the outer frame candidate 351 corresponding to an outer frame that cannot be subjected to outer frame flip without the flippable mark 357 added. That is, the control portion 27 displays, on the outer frame selection screen D5, the outer frame candidates 351 corresponding to an outer frame that can be subjected to outer frame flip and the outer frame candidate 351 corresponding to an outer frame that cannot be subjected to outer frame flip in different display modes. Accordingly, the user can determine whether or not the outer frame candidate 351 corresponds to an outer frame that can be subjected to outer frame flip.

In addition, when the outer frame candidate 351 corresponding to an outer frame that can be subjected to outer frame flip is selected on the outer frame selection screen D5, the control portion 27 causes the display portion 5 to display an flip type selection screen D6 on which three flip type candidates 371 respectively corresponding to “not flipped”, “left-right flip”, and “up-down flip” are displayed. Accordingly, the user can select the type of flip.

In addition, when the outer frame candidate 351 corresponding to an outer frame that cannot be subjected to outer frame flip is selected on the outer frame selection screen D5, the control portion 27 controls the display portion 5 such that the non-flipped outer frame 311 and the text 301 are displayed on the text screen D4 without displaying the flip type selection screen D6. Accordingly, the user can save the trouble of meaninglessly selecting an flip type on the flip type selection screen D6.

The tape printing apparatus 1 also includes the flip indicator 317, and the control portion 27 changes the display mode of the flip indicator 317 between when the flipped outer frame is displayed and when the flipped outer frame is not displayed. Accordingly, the user can determine whether or not the outer frame displayed on the text screen D4 is an flipped outer frame.

### OTHER MODIFICATION EXAMPLES

It is needless to say that the present disclosure is not limited to the above-described embodiment, and various configurations can be employed without departing from the gist thereof. For example, the above-described embodiment can be changed to the following aspects in addition to the above-described aspects. The contents described in one embodiment or modification example are similarly applied to other embodiments or modification examples, unless they are mutually inconsistent.

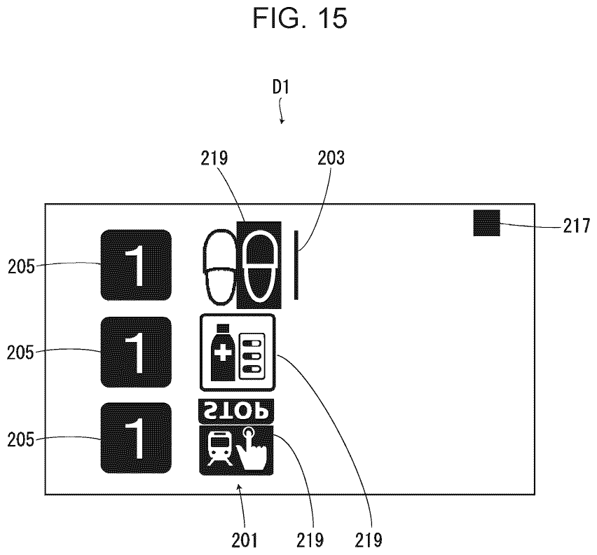

In the present embodiment, the entire first character 207 is configured to be subjected to character flip, but the present disclosure is not limited thereto. Only a part of the first character 207 may be configured to be subjected to character flip. That is, as shown in FIG. 15, the control portion 27 may generate, as the first flipped image data, partially flipped image data representing a partially flipped character 219 in which a part of the first character 207 is subjected to character flip. In this case, a partially flipped character 219 is displayed on the text screen D1 as a character constituting the text 201, in place of the first character 207. Moreover, in place of the first characters 207, the partially flipped character 219 is printed on the tape 113. Therefore, the partially flipped character 219 can be displayed in place of the first character 207 as a character constituting the text 201 on the text screen D1 without storing the partially flipped image data representing the partially flipped character 219 in the storage section 45 in advance.

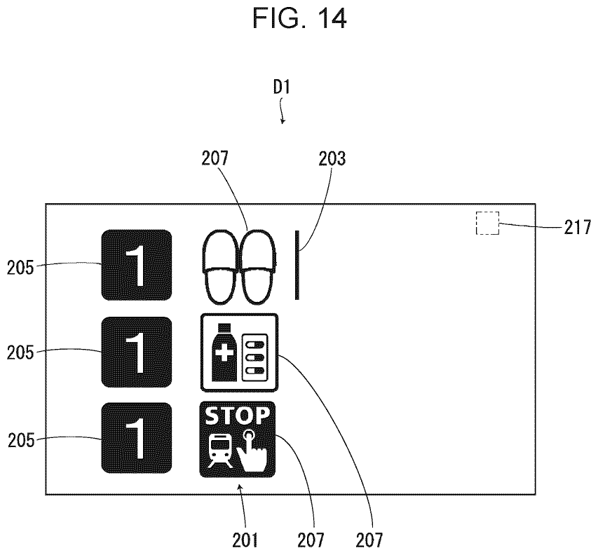

Each of the three partially flipped characters 219 shown in FIG. 15 is a character in which a part of the first character 207 shown in FIG. 14 is subjected to character flip. The partially flipped character 219 in the first paragraph is a character in which a part of the first character 207 on the right side is subjected to black-white inversion. The partially flipped character 219 in the second paragraph is a character in which a part of the first character 207 on the right side is subjected to left-right flip. The partially flipped character 219 in the third paragraph is a character in which a part of the first character 207 on the upper side is subjected to up-down flip.

In this case, the user may be configured to be able to select whether to perform character flip of the entire first character 207 or to perform character flip of a part of the first character 207. The portion of the first character 207 that can be subjected to character flip may be configured to be preset, or the user may be configured to be able to select the portion to be subjected to character flip each time.

In the present embodiment, the display mode of the flip indicator 217 is switched such that the user can identify whether or not the character displayed on the text screen D1 is the first flipped character 211. That is, the control portion 27 turns on the flip indicator 217 when the cursor 203 is positioned on the first flipped character 211, and turns off the flip indicator 217 when the cursor 203 is positioned on a character constituting the text 201 other than the first flipped character 211, but the present disclosure is not limited thereto. For example, in contrast to the present embodiment, the control portion 27 may be configured to turn on the flip indicator 217 when the cursor 203 is positioned on a character other than the first flipped character 211, and to turn off the flip indicator 217 when the cursor 203 is positioned on the first flipped character 211. Furthermore, the configuration is not limited to one in which the flip indicator 217 is provided within the display portion 5, that is, the display portion 5 functions as the flip indicator 217, and for example, a lamp provided separately from the display portion 5 may be configured to function as the flip indicator 217.

Furthermore, the method for enabling the user to identify whether or not the characters displayed on the text screen D1 are the first flipped characters 211 is not limited to the configuration of switching the display mode of the flip indicator 217. For example, the control portion 27 may be configured to control the display portion 5 such that the first character 207 is displayed in a lit manner and the first flipped character 211 is displayed in a blinking manner on the text screen D1.

In the present embodiment, the control portion 27 sets the target of character flip to the character on which the cursor 203 is positioned in the text screen D1 at the point in time when the flip key 41 is operated, but the present disclosure is not limited thereto. For example, the control portion 27 may be configured to set the target of character flip to the entire text 201 displayed on the text screen D1 at the point in time when the flip key 41 is operated. According to this configuration, it is possible to perform character flip of the entire text 201 at once by issuing a single flip instruction. Furthermore, the control portion 27 may be configured to set the target of character flip to the entire line or the entire paragraph where the cursor 203 is positioned in the text screen D1 at the point in time when the flip key 41 is operated. In these cases, the control portion 27 flips the characters of the entire text 201, the entire line, or the entire paragraph on a character-by-character basis. For example, when the entire text 201 is set as the target of left-right flip, the control portion 27 does not flip the entire text 201 left-right as a single image, but rather flips each character constituting the text 201 left-right on a character-by-character basis.

In the present embodiment, the display portion 5 is configured to function as a notification portion that notifies the user that the first character 207 cannot be subjected to character flip, but the present disclosure is not limited thereto, and for example, a lamp provided separately from the display portion 5 may be configured to function as the notification portion. Moreover, a speaker that outputs a warning sound or voice may be configured to function as the notification portion.

In the present embodiment, the flip menu screen D3 displays three selectable options as the flip options 214: “left-right flip”, “black-white inversion”, and “up-down flip”, but the present disclosure is not limited thereto. For example, when at least one of left-right flip, black-white inversion, and up-down flip is prohibited for the first character 207 that is the target of character flip, the corresponding flip option 214 may be configured to be grayed out, for example, on the flip menu screen D3, so that the user cannot select that flip option 214.

In the present embodiment, three types of character flip, left-right flip, black-white inversion, and up-down flip, can be performed; however, the present disclosure is not limited thereto, and it is sufficient that at least one of left-right flip, black-white inversion and up-down flip can be performed.

In the present embodiment, the control portion 27 performs three types of character flip, namely left-right flip, black-white inversion and up-down flip, individually, but the present disclosure is not limited thereto, and may be configured to be able to perform two or three of left-right flip, black-white inversion and up-down flip simultaneously. For example, the flip menu screen D3 displays at least one of “left-right-black-white flip”, “left-right-up-down flip”, “black-white-up-down flip” and “left-right-black-white-up-down flip”, as the flip option 214. When the flip option 214 of “left-right-black-white flip” is selected, the control portion 27 simultaneously performs left-right flip and black-white inversion. As a result, the first flipped character 211 in which the first character 207 is left-right flipped and black-white inverted is displayed on the text screen D1.

The control portion 27 may be configured to perform character rotation in addition to character flip. Accordingly, a first rotated character obtained by rotating the first character 207 is displayed on the text screen D1 in place of the first character 207.

In the present embodiment, character flip is prohibited for the second character 209, but the present disclosure is not limited thereto, and character flip may be configured to be permitted for the second character 209 as well. That is, in the character table 47, the left-right flip flag and the black-white inversion flag, and the up-down flip flag for each second character 209 may be configured to be set to “1: permitted”, except for characters whose appearance does not change even when the character flip is performed, for example.

In the present embodiment, an outer frame that does not change appearance even when the up-down flip is performed is defined as an “outer frame that cannot be subjected to up-down flip”, but the present disclosure is not limited thereto. For example, an outer frame that changes appearance only slightly when the up-down flip is performed may be defined as an “outer frame that cannot be subjected to up-down flip”. That is, an outer frame other than an outer frame having a shape that is linearly symmetrical with respect to a virtual center line extending in the left-right direction as the axis of symmetry may be defined as an “outer frame that cannot be subjected to up-down flip”. Similarly, an outer frame that changes appearance only slightly when left-right flip is performed may be defined as an “outer frame that cannot be subjected to left-right flip”. That is, an outer frame other than an outer frame having a shape that is linearly symmetrical with respect to a virtual center line extending in the vertical direction as the axis of symmetry may be defined as an “outer frame that cannot be subjected to left-right flip”.

In the present embodiment, the flip type selection screen D6 displays three flip type candidates 371 respectively corresponding to “not flipped”, “left-right flip”, and “up-down flip”, but the present disclosure is not limited thereto. For example, the control portion 27 may be configured not to display the flip type candidate 371 corresponding to “not flipped” on the flip type selection screen D6.

In addition, when the outer frame candidate 351 corresponding to an outer frame that can be subjected to left-right flip but cannot be subjected to up-down flip is selected on the outer frame selection screen D5, the control portion 27 may be configured not to display the flip type candidate 371 corresponding to “up-down flip” on the flip type selection screen D6. Similarly, when the outer frame candidate 351 corresponding to an outer frame that can be subjected to up-down flip but cannot be subjected to left-right flip is selected on the outer frame selection screen D5, the control portion 27 may be configured not to display the flip type candidate 371 of “left-right flip” on the flip type selection screen D6.

In addition, the control portion 27 may be configured to gray out the flip type candidate 371 corresponding to the flip type that cannot be flipped, rather than not displaying the flip type candidate 371 corresponding to the flip type that cannot be flipped on the flip type selection screen D6, thereby preventing the user from selecting that flip type candidate 371.

In addition, the control portion 27 may display other flip type candidates 371 on the flip type selection screen D6 in addition to the three flip type candidates 371 respectively corresponding to “not flipped”, “left-right flip”, and “up-down flip”. For example, the control portion 27 may display, as the flip type candidate 371, an flip type candidate 371 of “left-right-up-down flip”. When the flip type candidate 371 of “left-right-up-down flip” is selected, the control portion 27 displays a left-right-up-down flipped outer frame in which the entire non-flipped outer frame 311 is subjected to left-right flip and up-down flip on the text screen D4. The left-right-up-down flip is an example of “outer frame flip”, and the left-right-up-down flipped outer frame is an example of “flipped outer frame”.

Moreover, the control portion 27 may display, as the flip type candidate 371, an flip type candidate 371 of “left-right-black-white flip” or an flip type candidate 371 of “up-down-black-white flip”. For example, when the flip type candidate 371 of “left-right-black-white flip” is selected, the control portion 27 can print a label L on which a left-right-black-white flipped outer frame 333 and black-white inverted text 331 are printed, as shown in FIG. 34. The left-right-black-white flipped outer frame 333 is an outer frame in which the inside of the left-right flipped outer frame 313 is subjected to black-white inversion, the inside of which is obtained by subjecting the entire non-flipped outer frame 311 to left-right flip. Moreover, the black-white inverted text 331 is text that is subjected to neither left-right flip nor up-down flip but is subjected to black-white inversion. The same applies when the flip type candidate 371 of “up-down-black-white flip” is selected.

In the present embodiment, when an flipped outer frame is displayed in the print image display area E2 of the text screen D4, the flip indicator 317 is turned on, and when an flipped outer frame is not displayed, the flip indicator 317 is turned off, but the present disclosure is not limited thereto. For example, contrary to the present embodiment, when an flipped outer frame is displayed, the flip indicator 317 may be configured to be turned off, and when an flipped outer frame is not displayed, the flip indicator 317 may be configured to be turned on. Furthermore, the configuration is not limited to one in which the flip indicator 317 is provided within the display portion 5, that is, the display portion 5 functions as the flip indicator 317, and for example, a lamp provided separately from the display portion 5 may be configured to function as the flip indicator 317.

In the present embodiment, on the outer frame selection screen D5, the first outer frame candidate 351a corresponding to an outer frame that can be subjected to outer frame flip is displayed with an flippable mark 357 indicating that the outer frame flip is possible added, but the present disclosure is not limited thereto. For example, contrary to the present embodiment, the second outer frame candidate 351b corresponding to an outer frame that cannot be subjected to outer frame flip may be configured to be displayed with a non-flippable mark indicating that the outer frame flip is impossible added, and the first outer frame candidate 351a corresponding to an outer frame that can be subjected to outer frame flip may be configured to be displayed without the non-flippable mark added. The non-flipable mark is an example of an “additional image”. Additionally, the flippable mark 357 may be an image other than the character “R” enclosed in a circle. The form of the image is not limited for the non-flippable mark.

Moreover, a configuration may be employed in which either the first outer frame candidate 351a or the second outer frame candidate 351b is displayed in a blinking manner, and the other is displayed in a lit manner. For example, the outer frame image included in the first outer frame candidate 351a may be displayed in a blinking manner, and the outer frame image included in the second outer frame candidate 351b may be displayed in a lit manner.

In the present embodiment, the flipped outer frame or non-flipped outer frame 311 and the text 301 are displayed in the print image display area E2 of the text screen D4, but the flipped outer frame or non-flipped outer frame 311 and the text 301 may be displayed on a screen other than the text screen D4. For example, on a print preview screen that displays a print preview of the label L, the flipped outer frame or non-flipped outer frame 311 and the text 301 may be displayed. The print preview screen can be displayed, for example, by operating a print preview key included in the operation panel 3.

### ADDITIONAL NOTES

The tape printing apparatus and the control method of the tape printing apparatus will be additionally noted below.

A tape printing apparatus includes: a display portion; and a control portion having a storage section that stores image data representing a character, in which the control portion receives a selection of one first character from among a plurality of first characters on a first character selection screen displayed on the display portion, the control portion controls the display portion based on the image data representing the selected first character such that the selected first character is displayed on a text screen as a character constituting text to be printed, the control portion receives an flip instruction to display, on the text screen in place of the first character, a first flipped character in which the first character is subjected to character flip including at least one of left-right flip, black-white inversion, and up-down flip, the control portion generates first flipped image data representing the first flipped character based on the image data representing the first character when the flip instruction is received, and the control portion controls the display portion based on the generated first flipped image data such that the first flipped character is displayed on the text screen in place of the first character as the character constituting the text.

According to this configuration, it is possible to display the first flipped character in place of the first character as a character constituting the text on the text screen without storing the first flipped image data representing the first flipped character in which the first character is subjected to character flip in the storage section in advance. Therefore, it is possible to increase the number of printable character designs without increasing the capacity of the storage section.

In this case, it is preferable that the control portion generates, as the first flipped image data, partially flipped image data representing a partially flipped character in which a part of the first character is subjected to the character flip when the flip instruction is received.

According to this configuration, it is possible to display the partially flipped character in place of the first character as a character constituting the text on the text screen without storing the partially flipped image data representing the partially flipped character in which a part of the first character is subjected to the character flip in the storage section in advance.

In this case, it is preferable that the tape printing apparatus further includes an flip indicator, and the control portion changes a display mode of the flip indicator on the text screen between when a cursor is positioned on the character constituting the text other than the first flipped character and when the cursor is positioned on the first flipped character.

According to this configuration, it is possible to easily identify whether or not the character on which the cursor is positioned is the first flipped character.

In this case, it is preferable that the control portion controls the display portion such that, on the text screen, the character constituting the text other than the first flipped character is displayed in a lit manner, and the first flipped character is displayed in a blinking manner.

According to this configuration, it is possible to easily identify whether or not the character displayed on the text screen is the first flipped character.

In this case, it is preferable that the control portion sets the first character where a cursor is positioned on the text screen as a target of the character flip at a point in time when the flip instruction is received.

According to this configuration, it is possible to easily switch the first character to be the target of character flip by moving the cursor.

In this case, it is preferable that the control portion sets the entire text displayed on the text screen as a target of the character flip at a point in time when the flip instruction is received.

According to this configuration, it is possible to perform character flip of the entire text at once by issuing a single flip instruction.

In this case, it is preferable that the tape printing apparatus further includes a notification portion, the control portion determines whether or not the first character set as a target of the flip instruction is able to be subjected to the character flip when the flip instruction is received, and the control portion controls the notification portion to notify a user that the first character is not able to be subjected to the character flip when it is determined that the first character is not able to be subjected to the character flip.

According to this configuration, it is possible to notify the user that the first character to be a target of character flip cannot be subjected to character flip.

A control method of a tape printing apparatus is a control method of a tape printing apparatus including a display portion and a storage section that stores image data representing a character, the control method including: receiving a selection of one first character from among a plurality of first characters on a first character selection screen displayed on the display portion; controlling the display portion based on the image data representing the selected first character such that the selected first character is displayed on a text screen as a character constituting text to be printed; receiving an flip instruction to display, on the text screen in place of the first character, a first flipped character in which the first character is subjected to character flip including at least one of left-right flip, black-white inversion, and up-down flip; generating first flipped image data representing the first flipped character based on the image data representing the first character when the flip instruction is received; and controlling the display portion based on the generated first flipped image data such that the first flipped character is displayed on the text screen in place of the first character as the character constituting the text.

According to this configuration, it is possible to display the first flipped character in place of the first character as a character constituting the text on the text screen without storing the first flipped image data representing the first flipped character in which the first character is subjected to character flip in the storage section in advance. Therefore, it is possible to increase the number of printable character designs without increasing the capacity of the storage section.

A tape printing apparatus includes: a display portion; and a control portion having a storage section that stores image data representing an outer frame to be printed on a tape, in which the control portion receives an input of text to be disposed within the outer frame and printed on the tape, an input of a non-flipped outer frame based on the image data as the outer frame, and an input of an flipped outer frame in which the entire non-flipped outer frame is subjected to outer frame flip including at least one of left-right flip and up-down flip as the outer frame, and the control portion generates flipped image data representing the flipped outer frame based on the image data, and controls the display portion such that the flipped outer frame based on the generated flipped image data and the text disposed within the flipped outer frame without either left-right flip or up-down flip are displayed when the input of the flipped outer frame is received.

A control method of a tape printing apparatus is a control method of a tape printing apparatus including a display portion and a storage section that stores image data representing an outer frame to be printed on a tape, the control method including: by the tape printing apparatus, receiving an input of text to be disposed within the outer frame and printed on the tape, an input of a non-flipped outer frame based on the image data as the outer frame, and an input of an flipped outer frame in which the entire non-flipped outer frame is subjected to outer frame flip including at least one of left-right flip and up-down flip the outer frame; and generating flipped image data representing the flipped outer frame based on the image data, and controlling the display portion such that the flipped outer frame based on the generated flipped image data and the text disposed within the flipped outer frame without either left-right flip or up-down flip are displayed when the input of the flipped outer frame is received.

According to this configuration, the tape printing apparatus can display the flipped outer frame on the display portion without storing image data representing the flipped outer frame in the storage section in advance. Therefore, it is possible to increase the number of printable outer frame designs without increasing the capacity of the storage section.

In the tape printing apparatus described above, it is preferable that the control portion receives a selection of one outer frame candidate from among outer frame candidates that are candidates for the outer frame on an outer frame selection screen displayed on the display portion, and the control portion displays, on the outer frame selection screen, a first outer frame candidate that is the outer frame candidate corresponding to the outer frame that is able to be subjected to the outer frame flip and a second outer frame candidate that is the outer frame candidate corresponding to the outer frame that is not able to be subjected to the outer frame flip in different display modes.

According to this configuration, the user can determine on the outer frame selection screen whether or not the outer frame candidate corresponds to an outer frame that can be subjected to outer frame flip.

In the tape printing apparatus described above, it is preferable that the control portion displays, on the outer frame selection screen, the first outer frame candidate and the second outer frame candidate in different display modes by causing one of the first outer frame candidate and the second outer frame candidate to be displayed in a blinking manner, and causing another of the first outer frame candidate and the second outer frame candidate to be displayed in a lit manner.

According to this configuration, the user can determine whether or not the outer frame candidate corresponds to an outer frame that can be subjected to outer frame flip depending on whether or not the outer frame candidate is displayed in a blinking manner.

In the tape printing apparatus described above, it is preferable that the control portion displays, on the outer frame selection screen, the first outer frame candidate and the second outer frame candidate in different display modes by causing one of the first outer frame candidate and the second outer frame candidate to be displayed with an additional image added, and causing another of the first outer frame candidate and the second outer frame candidate to be displayed without the additional image added.

According to this configuration, the user can determine whether or not the outer frame candidate corresponds to an outer frame that can be subjected to outer frame flip depending on whether or not an additional image has been added.

In the tape printing apparatus described above, it is preferable that the control portion receives a selection of one outer frame candidate from among outer frame candidates that are candidates for the outer frame on an outer frame selection screen displayed on the display portion, the control portion causes the display portion to display an flip type selection screen on which two flip type candidates respectively corresponding to the left-right flip and the up-down flip are displayed when a first outer frame candidate that is the outer frame candidate corresponding to the outer frame that is able to be subjected to the outer frame flip is selected on the outer frame selection screen, and the control portion receives a selection of the flip type candidate on the flip type selection screen, and controls the display portion such that the flipped outer frame that is subjected to the outer frame flip according to the selected flip type candidate and the text are displayed.

According to this configuration, the user can select the flip type on the flip type selection screen.

In the tape printing apparatus, it is preferable that the control portion controls the display portion such that the non-flipped outer frame and the text are displayed without displaying the flip type selection screen on the display portion when a second outer frame candidate that is the outer frame candidate corresponding to the outer frame that is not able to be subjected to the outer frame flip is selected on the outer frame selection screen.

According to this configuration, the user can save the trouble of meaninglessly selecting an flip type on the flip type selection screen.

In the tape printing apparatus described above, it is preferable that the control portion does not display the flip type candidate corresponding to the up-down flip on the flip type selection screen when the first outer frame candidate corresponding to the outer frame that is able to be subjected to the left-right flip but that is not able to be subjected to the up-down flip is selected on the outer frame selection screen, and the control portion does not display the flip type candidate corresponding to the left-right flip on the flip type selection screen when the first outer frame candidate corresponding to the outer frame that is able to be subjected to the up-down flip but that is not able to be subjected to the left-right flip is selected on the outer frame selection screen.

According to this configuration, the user will not select an flip type candidate that corresponds to an flip type that cannot be flipped on the flip type selection screen.

It is preferable that the tape printing apparatus further includes an flip indicator, and the control portion changes a display mode of the flip indicator between when the flipped outer frame is displayed on the display portion and when the flipped outer frame is not displayed on the display portion.

According to this configuration, the user can determine whether or not the outer frame being displayed is an flipped outer frame.

What is claimed is:

1. A tape printing apparatus comprising:
a display portion; and
a control portion having a storage section that stores image data representing a character, wherein
the control portion receives a selection of one first character from among a plurality of first characters on a first character selection screen displayed on the display portion,
the control portion controls the display portion based on the image data representing the selected first character such that the selected first character is displayed on a text screen as a character constituting text to be printed,
the control portion receives an flip instruction to display, on the text screen in place of the first character, a first flipped character in which the first character is subjected to character flip including at least one of left-right flip, black-white inversion, and up-down flip,
the control portion generates first flipped image data representing the first flipped character based on the image data representing the first character when the flip instruction is received, and
the control portion controls the display portion based on the generated first flipped image data such that the first flipped character is displayed on the text screen in place of the first character as the character constituting the text.

2. The tape printing apparatus according to claim 1, wherein
the control portion generates, as the first flipped image data, partially flipped image data representing a partially flipped character in which a part of the first character is subjected to the character flip when the flip instruction is received.

3. The tape printing apparatus according to claim 1, further comprising:
an flip indicator, wherein
the control portion changes a display mode of the flip indicator on the text screen between when a cursor is positioned on the character constituting the text other than the first flipped character and when the cursor is positioned on the first flipped character.

4. The tape printing apparatus according to claim 1, wherein
the control portion controls the display portion such that, on the text screen, the character constituting the text other than the first flipped character is displayed in a lit manner, and the first flipped character is displayed in a blinking manner.

5. The tape printing apparatus according to claim 1, wherein
the control portion sets the first character where a cursor is positioned on the text screen as a target of the character flip at a point in time when the flip instruction is received.

6. The tape printing apparatus according to claim 1, wherein
the control portion sets the entire text displayed on the text screen as a target of the character flip at a point in time when the flip instruction is received.

7. The tape printing apparatus according to claim 1, further comprising:
a notification portion, wherein
the control portion determines whether or not the first character set as a target of the flip instruction is able to be subjected to the character flip when the flip instruction is received, and
the control portion controls the notification portion to notify a user that the first character is not able to be subjected to the character flip when it is determined that the first character is not able to be subjected to the character flip.

8. A control method of a tape printing apparatus including a display portion and a storage section that stores image data representing a character, the control method comprising:
receiving a selection of one first character from among a plurality of first characters on a first character selection screen displayed on the display portion;
controlling the display portion based on the image data representing the selected first character such that the selected first character is displayed on a text screen as a character constituting text to be printed;
receiving an flip instruction to display, on the text screen in place of the first character, a first flipped character in which the first character is subjected to character flip including at least one of left-right flip, black-white inversion, and up-down flip;
generating first i flipped mage data representing the first flipped character based on the image data representing the first character when the flip instruction is received; and
controlling the display portion based on the generated first flipped image data such that the first flipped character is displayed on the text screen in place of the first character as the character constituting the text.

9. A tape printing apparatus comprising:
a display portion; and
a control portion having a storage section that stores image data representing an outer frame to be printed on a tape, wherein
the control portion receives an input of text to be disposed within the outer frame and printed on the tape, an input of a non-flipped outer frame based on the image data as the outer frame, and an input of an flipped outer frame in which the entire non-flipped outer frame is subjected to outer frame flip including at least one of left-right flip and up-down flip as the outer frame, and
the control portion generates flipped image data representing the flipped outer frame based on the image data, and controls the display portion such that the flipped outer frame based on the generated flipped image data and the text disposed within the flipped outer frame without either left-right flip or up-down flip are displayed when the input of the flipped outer frame is received.

10. The tape printing apparatus according to claim 9, wherein
the control portion receives a selection of one outer frame candidate from among outer frame candidates that are candidates for the outer frame on an outer frame selection screen displayed on the display portion, and
the control portion displays, on the outer frame selection screen, a first outer frame candidate that is the outer frame candidate corresponding to the outer frame that is able to be subjected to the outer frame flip and a second outer frame candidate that is the outer frame candidate corresponding to the outer frame that is not able to be subjected to the outer frame flip in different display modes.

11. The tape printing apparatus according to claim 10, wherein
the control portion displays, on the outer frame selection screen, the first outer frame candidate and the second outer frame candidate in different display modes by causing one of the first outer frame candidate and the second outer frame candidate to be displayed in a blinking manner, and causing another of the first outer frame candidate and the second outer frame candidate to be displayed in a lit manner.

12. The tape printing apparatus according to claim 10, wherein
the control portion displays, on the outer frame selection screen, the first outer frame candidate and the second outer frame candidate in different display modes by causing one of the first outer frame candidate and the second outer frame candidate to be displayed with an additional image added, and causing another of the first outer frame candidate and the second outer frame candidate to be displayed without the additional image added.

13. The tape printing apparatus according to claim 9, wherein
the control portion receives a selection of one outer frame candidate from among outer frame candidates that are candidates for the outer frame on an outer frame selection screen displayed on the display portion,
the control portion causes the display portion to display an flip type selection screen on which two flip type candidates respectively corresponding to the left-right flip and the up-down flip are displayed when a first outer frame candidate that is the outer frame candidate corresponding to the outer frame that is able to be subjected to the outer frame flip is selected on the outer frame selection screen, and
the control portion receives a selection of the flip type candidate on the flip type selection screen, and controls the display portion such that the flipped outer frame that is subjected to the outer frame flip according to the selected flip type candidate and the text are displayed.

14. The tape printing apparatus according to claim 13, wherein
the control portion controls the display portion such that the non-flipped outer frame and the text are displayed without displaying the flip type selection screen on the display portion when a second outer frame candidate that is the outer frame candidate corresponding to the outer frame that is not able to be subjected to the outer frame flip is selected on the outer frame selection screen.

15. The tape printing apparatus according to claim 13, wherein
the control portion does not display the flip type candidate corresponding to the up-down flip on the flip type selection screen when the first outer frame candidate corresponding to the outer frame that is able to be subjected to the left-right flip but that is not able to be subjected to the up-down flip is selected on the outer frame selection screen, and
the control portion does not display the flip type candidate corresponding to the left-right flip on the flip type selection screen when the first outer frame candidate corresponding to the outer frame that is able to be subjected to the up-down flip but that is not able to be subjected to the left-right flip is selected on the outer frame selection screen.

16. The tape printing apparatus according to claim 9, further comprising:
an flip indicator, wherein
the control portion changes a display mode of the flip indicator between when the flipped outer frame is displayed on the display portion and when the flipped outer frame is not displayed on the display portion.

17. A control method of a tape printing apparatus including a display portion and a storage section that stores image data representing an outer frame to be printed on a tape, the control method comprising:
by the tape printing apparatus,
receiving an input of text to be disposed within the outer frame and printed on the tape, an input of a non-flipped outer frame based on the image data as the outer frame, and an input of an flipped outer frame in which the entire non-flipped outer frame is subjected to outer frame flip including at least one of left-right flip and up-down flip as the outer frame; and
generating flipped image data representing the flipped outer frame based on the image data, and controlling the display portion such that the flipped outer frame based on the generated flipped image data and the text disposed within the flipped outer frame without either left-right flip or up-down flip are displayed when the input of the flipped outer frame is received.
